(19) United States
(12) Patent Application Publication
(10) Pub. No.: US 2024/0294801 A1
(43) Pub. Date: Sep. 5, 2024

(54) A COATING COMPOSITION

(71) Applicant: PPG Industries Ohio, Inc., Cleveland, OH (US)

(72) Inventors: Christelle Nathalie Witt-Sanson, Ofterdingen (DE); Fabio Werner Krohm, Ofterdingen (DE); Grzegorz Szczepan Kondziolka, Zebrzydowice (PL); Nigel Francis Masters, Essex (GB)

(73) Assignee: PPG Industries Ohio, Inc., Cleveland, OH (US)

(21) Appl. No.: 18/262,019

(22) PCT Filed: Jan. 20, 2022
(86) PCT No.: PCT/US2022/013180

§ 371 Date: Jul. 19, 2023

Related U.S. Application Data
(60) Provisional application No. 63/139,841, filed on Jan. 21, 2021.

(51) Int. Cl. C09D 179/08; B65B 31/00; B65D 85/72

(52) U.S. Cl. CPC C09D 179/08; B65B 31/00; B65D 85/72

(57) ABSTRACT

A coating composition comprising: a) a polyester imide polymer having an acid value of at least 25 mg KOH/g and a hydroxyl value of up to 5 mg KOH/g; and b) a crosslinker material operable to crosslink the acid functionality of the polyester imide polymer, wherein the coating composition is substantially free of bisphenol A (BRA), bisphenol F (BPF), bisphenol A diglycidyl ether (BADGE) and bisphenol F diglycidyl ether (BFDGE).

### FIELD OF THE INVENTION

The present invention relates to a coating composition comprising a polyester imide resin. The present invention relates to a coating composition comprising a polyester imide resin for coating onto a metal substrate, such as a metal substrate used in the packaging industry, such as coating onto food and/or beverage packaging, components used to fabricate such packaging, or monobloc aerosol cans and/or tubes. Such coatings may include liquid or powder coatings, such as thermoset powder coatings, for example. The invention also extends to metal substrates coated on at least a portion thereof with a coating, the coating being derived from such coating compositions.

### BACKGROUND OF THE INVENTION

The surfaces of containers, such as food and/or beverage containers, containers for personal care products or aerosol containers are required to be coated for various reasons. The external surfaces of such containers are often coated in a decorative manner and may allow printing thereon to inform a user as to the contents of the container. The internal surfaces of such container are typically coated to protect the container from the contents therein, which in some instances may be chemically aggressive. The coating on the container should also protect the contents from the container. There should be a minimal amount of alteration to the contents from materials that are products of erosion of the container, or from the coating itself. Accordingly, the coating composition used to coat the internal surfaces of the container should be designed such that it is able to withstand contact with these aggressive chemicals and to minimise the release of material from the metal of the container or the coating layer into the contents of the container.

A wide variety of coatings have been used to coat containers. With regard to food and/or beverage containers, the coating compositions often have certain properties such as being capable of high speed application, having excellent adhesion to the substrate, being safe for food contact and having properties once cured that are suitable for their end use. Typically, coatings have one, or maybe two, of these properties depending on their final end use.

Packaging used for the storage of aerosols (aerosol cans, for example), such as personal healthcare aerosols, or industrial use aerosols, are typically formed from a tube, for example, an aluminium tube. One such tube type is a monobloc aerosol, which is so called because it is formed from a single piece (a small disc known as a “slug”) of aluminium. Such aluminium tubes can also be formed into bottle shapes, so called “monobloc bottles” and used for beer and other beverages, for example.

### SUMMARY OF THE INVENTION

According to the present invention there is provided a coating composition comprising:
a) a polyester imide polymer having an acid value of at least 25 mg KOH/g and a hydroxyl value of up to 5 mg KOH/g; and
b) a crosslinker material operable to crosslink the acid functionality of the polyester imide polymer,
   wherein the coating composition is substantially free of bisphenol A (BPA), bisphenol F (BPF),
bisphenol A diglycidyl ether (BADGE) and bisphenol F diglycidyl ether (BFDGE).

There is also provided a metal substrate coated on at least a portion thereof with a coating, the coating being derived from a coating composition, the coating composition comprising:
a) a polyester imide polymer having an acid value of at least 25 mg KOH/g and a hydroxyl value of up to 5 mg KOH/g; and
b) a crosslinker material operable to crosslink the acid functionality on the polyester imide polymer,
   wherein the coating composition is substantially free of bisphenol A (BPA), bisphenol F (BPF), bisphenol A diglycidyl ether (BADGE) and bisphenol F diglycidyl ether (BFDGE).

There is also provided a package coated on at least a portion thereof with a coating, the coating being derived from a coating composition, the coating composition comprising:
a) a polyester imide polymer having an acid value of at least 25 mg KOH/g and a hydroxyl value of up to 5 mg KOH/g; and
b) a crosslinker material operable to crosslink the acid functionality on the polyester imide polymer,
   wherein the coating composition is substantially free of bisphenol A (BPA), bisphenol F (BPF), bisphenol A diglycidyl ether (BADGE) and bisphenol F diglycidyl ether (BFDGE).

There is also provided a food and/or beverage package coated on at least a portion thereof with a coating, the coating being derived from a coating composition, the coating composition comprising:
a) a polyester imide polymer having an acid value of at least 25 mg KOH/g and a hydroxyl value of up to 5 mg KOH/g; and
b) a crosslinker material operable to crosslink the acid functionality on the polyester imide polymer,
   wherein the coating composition is substantially free of bisphenol A (BPA), bisphenol F (BPF), bisphenol A diglycidyl ether (BADGE) and bisphenol F diglycidyl ether (BFDGE).

There is also provided a monobloc aerosol can and/or tube coated on at least a portion thereof with a coating, the coating being derived from a coating composition, the coating composition comprising:
a) a polyester imide polymer having an acid value of at least 25 mg KOH/g and a hydroxyl value of up to 5 mg KOH/g; and
b) a crosslinker material operable to crosslink the acid functionality on the polyester imide polymer,
   wherein the coating composition is substantially free of bisphenol A (BPA), bisphenol F (BPF), bisphenol A diglycidyl ether (BADGE) and bisphenol F diglycidyl ether (BFDGE).

There is also provided a method of making a metal package having a coating on at least a portion thereof, the method comprising:
i) applying a coating composition to at least a portion of the metal package, the coating composition comprising:
   a) a polyester imide polymer having an acid value of at least 25 mg KOH/g and a hydroxyl value of up to 5 mg KOH/g; and
   b) a crosslinker material operable to crosslink the acid functionality on the polyester imide polymer, to at least a portion of a surface of a metal package; and
ii) curing the coating composition to form a coating.

### DETAILED DESCRIPTION OF THE INVENTION

The coating compositions comprise a polyester imide (PEI) polymer. Typically, the polyester imide polymer comprises a polyester linkage and an imide in the backbone of the polymer.

The polyester imide polymer may be formed from an imide containing moiety. The imide containing moiety may also comprise an acid group and/or an alcohol group. The imide containing moiety may contain at least two acid groups, at least two alcohol groups or an acid group and an alcohol group.

The imide containing moiety may contain a cyclic imide group.

The imide containing moiety may be formed as a reaction product of reactants comprising a primary amine or an isocyanate with a cyclic anhydride. For example, typical components in such a reaction may include a difunctional isocyanate such as methylene di-phenyl di-isocyanate, with an anhydride such as trimellitic anhydride.

For example, such a reaction is shown in Scheme I, below.

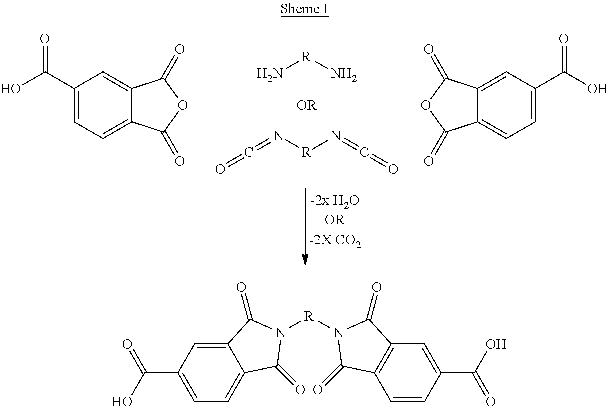

As can be seen from the above reaction scheme, the formed imide containing moiety may be a diacid substituted imide, which may then be reacted with a diol (ethylene glycol, for example) in a polyesterification reaction to thereby form an imide containing polyester (polyester imide).

An alternative example of forming an imide containing moiety is shown in scheme 2, below. Scheme 2 shows the reaction of trimellitic anhydride with bis (4-isocyanatocyclohexyl) methane to form a di-imide di-acid.

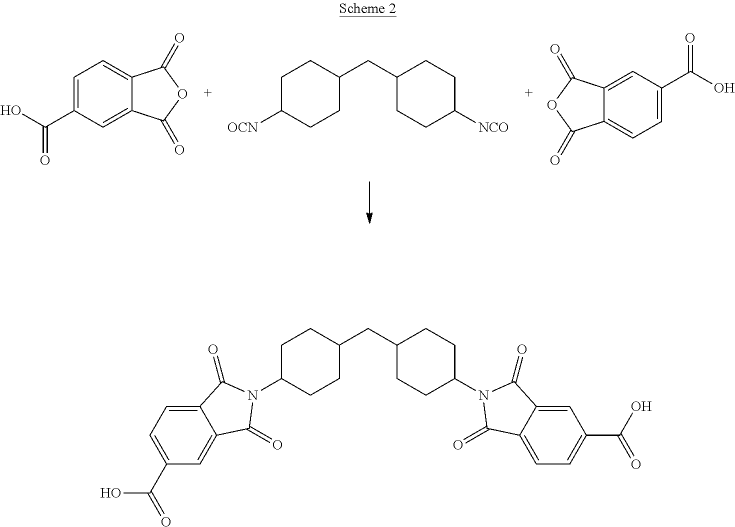

In a further example, a reaction leading to the formation of an imide containing moiety which is monoacid, monohydroxyl substituted is shown in scheme 3, below. In this example, a primary amine with additional hydroxyl functionality, mono ethanol amine, reacts with trimellitic anhydride to produce a cyclic imide with hydroxyl and acid functionality. The mono imide product shown in scheme 3 may then react with other diols, polyols and diacids in a polyesterification reaction to thereby form an imide containing polyester (polyester imide).

Alternatively or additionally, the reaction product in Scheme 3 may self condense in a polyesterification reaction.

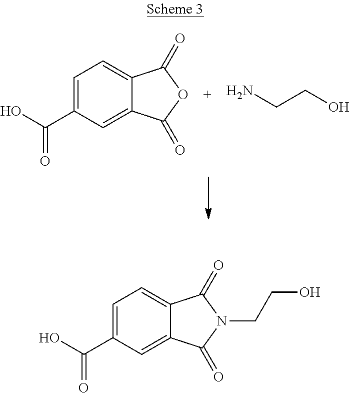

Examples of suitable amines that could be used include diamines such as, for example, ethylene diamine; 1,3-propane diamine; tetramethylene diamine; 1,6-hexane diamine; trimethyl hexane-1,6-diamine; isophrone diamine diaminodiphenylmethane (methylene dianaline); diaminodiphenylether; diaminodiphenylsulphone; methylene-4 4′-cyclohexyl diamine; benzoguanamine; ortho-xylylene diamine; meta-xylylene diamine; para-xylylenediamine; 1,2-cyclohexanediamine; 1,4-cyclohexanediamine; amines can also include hydroxyamines such as monoethanol amine; monopropanolamine; or aminocarboxylic acids such as glycine; aminopropionic acids or amino benzoic acids; and combinations thereof.

Examples of suitable isocyanates include, for example, hexamethylene di-isocyanate; tetramethylene di-isocyanate; isophorone di-isocyanate; methylene-4,4′-bis (cyclohexyl isocyanate) or bis-(4-isocyanatocyclohexyl)methane; methylene di phenyl di-isocyanate or bis-(4-isocyanatophenyl)methane; tetramethyl-meta-xylylene di-isocyanate; meta xylylene di-isocyanate; para xylylene di-isocyanate; cyclohexane di-isocyanate; naphthalene di-isocyanate; trimethyl hexamethylene di-isocyanate; and combinations thereof.

Examples of suitable cyclic anhydrides include trimellitic anhydride; pyromellitic di-anhydride; maleic anhydride; 3,3′,4,4′-benzophenonetetracarboxylic dianhydride; tetrahydrophthalic anhydride; 1,4,5,-naphthalenetricarboxylic anhydride; 1,4,5,8-naphthalenetetracarboxylic dianhydride; hemimellitic anhydride; and combinations thereof.

The imide containing moiety may be formed in the substantial absence of diol or polyol (i.e. less than 1%, such as less than 0.5%, such as less than 0.1%, such as less than 0.05%, or even less than 0.01% by weight diol or polyol). The imide containing moiety may be formed in the absence of diol or polyol.

Alternatively, the imide containing moiety may be formed in the presence of a diol or polyol.

The polyester imide polymer may be formed by reaction of an imide containing moiety with a diol, polyol (or other primarily hydroxy functional branching monomer), dicarboxylic acid, diester or a component containing one acid (or ester) and one alcohol group, as the case may be (depending on the functionality of the imide) to thereby form a polyester.

“Polyol” and like terms, as used herein, refers to a compound having two or more hydroxyl groups, such as two, three or four hydroxyl groups. The hydroxyl groups of the polyol may be connected by a bridging group selected from: an alkylene group; an alkenylene group; an alkynylene group; or an arylene group. The polyol may be an organic polyol.

“Diol” and like terms, as used herein, refers to a compound having two hydroxyl groups. The hydroxyl groups of the diol may be connected by a bridging group selected from: an alkylene group; an alkenylene group; an alkynylene group; or an arylene group. The diol may be an organic polyol.

Examples of suitable diols include, but are not limited to, the following: ethylene glycol; 1,2-propane diol; 1,3-propane diol; 1,2-butanediol; 1,3-butandiol; 1,4-butanediol; 2,3-butane diol; 2-methyl-1,3-propane diol; 2,2′-dimethyl-1,3-propanediol; 1,5-pentane diol; 3-methyl-1,5-pentanediol; 1,6-hexane diol; diethylene glycol; triethylene glycol; dipropylene glycol; tripropylene glycol; 2,2,4-trimethyl pentane-1,3-diol; 1,4-cyclohexane dimethanol; tricyclodecane dimethanol; 2,2,4,4-tetramethyl cyclobutane-1,3-diol; isosorbide; 1,4-cyclohexane diol; 1,1′-isopropylidene-bis-(4-cyclohexanol); and combinations thereof.

Examples of suitable polyols (or other, primarily hydroxy, functional branching monomer) include, but are not limited to, the following: tris (hydroxyethyl)isocyanurate; trimethylol propane; trimethylol ethane; 1,2,6-hexane triol; pentaerythritol; erythritol; di-trimethylol propane; di-pentaerythritol; N,N,N′,N′-tetra (hydroxyethyl)adipindiamide; N,N,N′,N′-tetra (hydroxypropyl)adipindiamide; tri(hydroxy ethyl) amine; hexahydro-1,3,5-tris(hydroxyethyl)-s-triazine; N,N,N′,N′-tetrakis-(hydroxyethyl)ethylenediamine; di ethanol amine; or combinations thereof.

“Diacid” and like terms as used herein, refers to a compound having two carboxylic acid groups and includes an ester of the diacid (wherein an acid group is esterified) or an anhydride. The diacid may be an organic polyacid.

The carboxylic acid groups of the diacid may be connected by a bridging group selected from: an alkylene group; an alkenylene group; an alkynylene group; or an arylene group.

Examples of suitable diacids include, but are not limited to, the following: isophthalic acid; terephthalic acid; 1,4-cyclohexane dicarboxylic acid; succinic acid; adipic acid; azelaic acid; sebacic acid; fumaric acid; 2,6-naphthalene dicarboxylic acid; orthophthalic acid. Diacids can also be used in the form of the diester materials, such as: dimethyl ester derivatives such as dimethyl isophthalate; dimethyl terephthalate; dimethyl-1,4-cyclohexane dicarboxylate; dimethyl-2,6-naphthalene dicarboxylate; dimethyl fumarate; dimethyl orthophthalate; dimethylsuccinate; dimethyl glutarate; dimethyl adipate; or combinations thereof.

The term “alk” or “alkyl”, as used herein unless otherwise defined, relates to saturated hydrocarbon radicals being straight, branched, cyclic or polycyclic moieties or combinations thereof and contain 1 to 20 carbon atoms, such as 1 to 10 carbon atoms, such as 1 to 8 carbon atoms, such as 1 to 6 carbon atoms, or even 1 to 4 carbon atoms. These radicals may be optionally substituted with a chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, aryl or Het, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from methyl, ethyl, n-propyl, isopropyl, n-butyl, isobutyl, sec-butyl, tert-butyl, 2-methylbutyl, pentyl, iso-amyl, hexyl, cyclohexyl, 3-methylpentyl, octyl and the like. The term “alkylene”, as used herein, relates to a bivalent radical alkyl group as defined above. For example, an alkyl group such as methyl which would be represented as —CH₃, becomes methylene, —CH₂—, when represented as an alkylene. Other alkylene groups should be understood accordingly.

The term “alkenyl”, as used herein, relates to hydrocarbon radicals having, such as up to 4, double bonds, being straight, branched, cyclic or polycyclic moieties or combinations thereof and containing from 2 to 18 carbon atoms, such as 2 to 10 carbon atoms, such as from 2 to 8 carbon atoms, such as 2 to 6 carbon atoms, or even 2 to 4 carbon atoms. These radicals may be optionally substituted with a hydroxyl, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from alkenyl groups include vinyl, allyl, isopropenyl, pentenyl, hexenyl, heptenyl, cyclopropenyl, cyclobutenyl, cyclopentenyl, cyclohexenyl, 1-propenyl, 2-butenyl, 2-methyl-2-butenyl, isoprenyl, farnesyl, geranyl, geranylgeranyl and the like. The term “alkenylene”, as used herein, relates to a bivalent radical alkenyl group as defined above. For example, an alkenyl group such as ethenyl which would be represented as —CH═CH2, becomes ethenylene, —CH═CH—, when represented as an alkenylene. Other alkenylene groups should be understood accordingly.

The term “alkynyl”, as used herein, relates to hydrocarbon radicals having, such as up to 4, triple bonds, being straight, branched, cyclic or polycyclic moieties or combinations thereof and having from 2 to 18 carbon atoms, such as 2 to 10 carbon atoms, such as from 2 to 8 carbon atoms, such as from 2 to 6 carbon atoms, or even from 2 to 4 carbon atoms. These radicals may be optionally substituted with a hydroxy, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶ or aryl, wherein R¹⁹ to R²⁷ each independently represent hydrogen, aryl or lower alkyl, and/or be interrupted by oxygen or sulphur atoms, or by silano or dialkylsiloxane groups. Examples of such radicals may be independently selected from alkynyl radicals include ethynyl, propynyl, propargyl, butynyl, pentynyl, hexynyl and the like. The term “alkynylene”, as used herein, relates to a bivalent radical alkynyl group as defined above. For example, an alkynyl group such as ethynyl which would be represented as —C≡CH, becomes ethynylene, —C≡C—, when represented as an alkynylene. Other alkynylene groups should be understood accordingly.

The term “aryl” as used herein, relates to an organic radical derived from an aromatic hydrocarbon by removal of one hydrogen, and includes any monocyclic, bicyclic or polycyclic carbon ring of up to 7 members in each ring, wherein a ring is aromatic. These radicals may be optionally substituted with a hydroxy, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or lower alkyl, and/or be interrupted by oxygen or sulphur atoms, or by silano or dialkylsilcon groups. Examples of such radicals may be independently selected from phenyl, p-tolyl, 4-methoxyphenyl, 4-(tert-butoxy)phenyl, 3-methyl-4-methoxyphenyl, 4-fluorophenyl, 4-chlorophenyl, 3-nitrophenyl, 3-aminophenyl, 3-acetamidophenyl, 4-acetamidophenyl, 2-methyl-3-acetamidophenyl, 2-methyl-3-aminophenyl, 3-methyl-4-aminophenyl, 2-amino-3-methylphenyl, 2,4-dimethyl-3-aminophenyl, 4-hydroxyphenyl, 3-methyl-4-hydroxyphenyl, 1-naphthyl, 2-naphthyl, 3-amino-1-naphthyl, 2-methyl-3-amino-1-naphthyl, 6-amino-2-naphthyl, 4,6-dimethoxy-2-naphthyl, tetrahydronaphthyl, indanyl, biphenyl, phenanthryl, anthryl or acenaphthyl and the like. The term “arylene”, as used herein, relates to a bivalent radical aryl group as defined above. For example, an aryl group such as phenyl which would be represented as -Ph, becomes phenylene, -Ph-, when represented as an arylene. Other arylene groups should be understood accordingly.

For the avoidance of doubt, the reference to alkyl, alkenyl, alkynyl, aryl or aralkyl in composite groups herein should be interpreted accordingly, for example the reference to alkyl in aminoalkyl or alk in alkoxyl should be interpreted as alk or alkyl above etc.

The formation of the polyester imide polymer (the polyesterification) may take place in the presence of a catalyst. Suitable catalysts include: tetra n-butyl titanate; tetra iso-propyl titanate; tetra ethyl hexyl titanate; zinc acetate; di butyl tin oxide; butyl stannoic acid; or combinations thereof.

The polyester imide polymer may be formed by first reacting a cyclic anhydride component with an amine or isocyanate component at a suitable temperature to produce a cyclic imide with reactive functionality in a first stage reaction (imide preparation reaction), which may be undertaken in the presence of a promoter/catalyst. However, in some cases catalysis may not be required. In a second stage reaction (polyesterification reaction) the other components diols, polyols and diacid or ester derivatives as the case may be (depending on the functionality of the imide) may be added to the product of the first stage reaction, together with appropriate catalysts (where required).

The amount of diol and polyol present in the polyesterification reaction may be sufficient to provide an excess of hydroxyl functionality in the formation which may initially provide a predominant hydroxyl functionality in the polyester imide polymer. The polyesterification reaction may be carried out at sufficient temperature to allow for removal of water or alcohol (such as methanol) by-product as the polymer is formed. The polyesterification reaction progress may be monitored by appropriate methods including: amount of distillate released, acid value of the polymer (measured in units of mg KOH/g) or viscosity (melt viscosity or solution viscosity) of the polymer. The polyester imide polymer may have functional end groups including hydroxyl groups, acid groups or ester groups from mono alcohols.

The polyester imide polymer may be formed by first reacting a cyclic anhydride component with an amine or isocyanate component in the presence of some or all of the diol component at a suitable temperature to produce the cyclic imide with reactive functionality. In such a first stage reaction, a promoter and/or catalyst may be added. However, in some cases catalysis may not be required.

In a second stage the other components of the polyester imide, including any remaining diols, polyols and diacid or ester derivatives may be added together with appropriate catalysts. The amount of diol and polyol added may be sufficient to provide an excess of hydroxyl functionality which provides a predominant hydroxyl functionality in the polyester imide polymer.

The second stage reaction may be carried out at sufficient temperature to allow for removal of water or alcohol (such as methanol) by-product, as the polymer is formed. The second stage reaction progress may be monitored by appropriate methods including amount of distillate released, acid and/or hydroxyl value of the polymer (measured in units of mg KOH/g) or viscosity (melt viscosity or solution viscosity) of the polymer. The polyester imide polymer has functional end groups including hydroxyl groups, acid groups or ester groups from monoalcohols.

The polyester imide polymer may be formed by first reacting diols, polyols and diacid or ester derivatives (a polyesterification reaction) which may be undertaken in the presence of a promoter and/or catalyst. However, in some cases catalysts may not be required. In a second stage reaction a cyclic anhydride component and an amine component (or possibly an isocyanate component) are added and the subsequent reaction is conducted at a suitable temperature to produce a cyclic imide with reactive functionality which further reacts with the polyester oligomers formed in a first stage reaction (polyesterification reaction). Appropriate catalysts and/or reaction promoters can be added as required, however, in some cases catalysts may not be required.

The amount of diol and polyol present in the polyesterification reaction may be sufficient to provide an excess of hydroxyl functionality, which may provide the predominant hydroxyl functionality in the polymer. The polyesterification reaction may be carried out at sufficient temperature to allow for removal of water or alcohol (such as methanol) by-product as the polymer is formed. The polyesterification reaction progress, in stage 1, and the imide formation and reaction, in stage 2, may be monitored by appropriate methods including: amount of distillate released, acid value of the polymer (measured in units of mgKOH/gm) or viscosity (melt viscosity or solution viscosity) of the polymer. The polyester imide polymer may have functional end groups including hydroxyl groups, acid groups or ester groups from mono alcohols.

The polyester imide polymer has an acid value of ≥10 mg KOH/g. The polyester imide polymer may be formed by contacting a polyester imide (formed as described above, for example) with an acidifying component. The acidifying component may be selected from an acid, a diacid, a polyacid anhydrides thereof, or mixtures thereof. Examples of suitable acidifying components include, but are not limited to, the following: isophthalic acid; terephthalic acid; 1,4-cyclohexane dicarboxylic acid; succinic acid; adipic acid; azelaic acid; sebacic acid; fumaric acid; 2,6-naphthalene dicarboxylic acid; orthophthalic acid; trimellitic anhydride, succinic anhydride; maleic anhydride; tetrahydrophthalic anhydride or combinations thereof.

The polyester imide polymer may comprise at least 1 wt % of imide based on the total weight of the components, such as in the backbone thereof. The polyester imide polymer may comprise at least 2 wt %, such as at least 3 wt % of imide based on the total weight of the components, such as in the backbone thereof.

The polyester imide polymer may comprise less than 50 wt %, such as less than 30 wt % imide based on the total weight of the components, such as in the backbone thereof. The polyester imide polymer may comprise less than 25 wt %, such as less than 20 wt % imide based on the total weight of the components, such as in the backbone thereof.

The polyester imide polymer may comprise from 2 and 20 wt %, such as from 4 and 18 wt % imide based on the total weight of the components, such as in the backbone thereof.

In referring to a percentage of imide present in the polyester imide polymer, based on the total weight of the components, it is meant the following. The polyester imide polymers contain imide units made up of the chemical structural unit [—N(C═O)₂—], which has an atomic mass of 70 gmol⁻¹. In order to get some quantification of weight of the polymer components which can theoretically form imide a calculation can be used to determine the percentage weight of imide by weight of components. The calculation is shown below:

[mols of imide used (or mols of components that form the imide, such as the cyclic anhydride)×70×100]/[sum total weight of polymer components]

The proportion of imide formed in the polyester imide polymers of the invention can also be characterised by reference to the molar proportions of the components. We can refer to the ratio of molar amount of imide forming groups to the molar amount of ester forming groups (the molar amount of carboxylic acid or their equivalents such as the amount of methyl esters). This can then be used to calculate a % imide equivalent, as per the calculation below:

$$[ mols of imide forming group ( or cyclic anhydride ) \times 100 ] /$$

$$[ ( mols of imide forming group ) + ( mols of ester forming group ) ]$$

The polyester imide polymer may have a percentage imide equivalent value of at least 5%, such as at least 10%, or even at least 15%.

The polyester imide polymer may have a percentage imide equivalent value of less than 60%, such as less than 50%, or even less than 45%.

The polyester imide polymer may have a percentage imide equivalent value of from 5 and 50%, such as from 13 and 45%, or even from 18 and 41%.

The polyester imide polymer has an acid value (AV) of at least 25 mg KOH/g.

The polyester imide polymer may have an acid value of at least 30 mg KOH/g, such as at least 35 mg KOH/g, such as at least 40 mg KOH/g, such as at least 45 mg KOH/g, such as at least 50 mg KOH/g, such as at least 55 mg KOH/g, such as at least 60 mg KOH/g, such as at least 65 mg KOH/g, such as at least 70 mg KOH/g, such as at least 75 mg KOH/g, or even at least 80 mg KOH/g. The polyester imide polymer may have an acid value of up to 250 mg KOH/g, such as up to 200 mg KOH/g, such as up to 150 mg KOH/g, such as up to 120 mg KOH/g, or even up to 100 mg KOH/g.

The polyester imide polymer may have an acid value of from 30 to 250 mg KOH/g, such as from 30 to 200 mg KOH/g, such as from 30 to 150 mg KOH/g, such as from 30 to 120 mg KOH/g, such as from 30 to 100 mg KOH/g. The polyester imide polymer may have an acid value of from 35 to 250 mg KOH/g, such as from 35 to 200 mg KOH/g, such as from 35 to 150 mg KOH/g, such as from 35 to 120 mg KOH/g, such as from 35 to 100 mg KOH/g. The polyester imide polymer may have an acid value of from 40 to 250 mg KOH/g, such as from 40 to 200 mg KOH/g, such as from 40 to 150 mg KOH/g, such as from 40 to 120 mg KOH/g, such as from 40 to 100 mg KOH/g. The polyester imide polymer may have an acid value of from 45 to 250 mg KOH/g, such as from 45 to 200 mg KOH/g, such as from 45 to 150 mg KOH/g, such as from 45 to 120 mg KOH/g, such as from 45 to 100 mg KOH/g. The polyester imide polymer may have an acid value of from 50 to 250 mg KOH/g, such as from 50 to 200 mg KOH/g, such as from 50 to 150 mg KOH/g, such as from 50 to 120 mg KOH/g, such as from 50 to 100 mg KOH/g. The polyester imide polymer may have an acid value of from 55 to 250 mg KOH/g, such as from 55 to 200 mg KOH/g, such as from 55 to 150 mg KOH/g, such as from 55 to 120 mg KOH/g, such as from 55 to 100 mg KOH/g. The polyester imide polymer may have an acid value of from 60 to 250 mg KOH/g, such as from 60 to 200 mg KOH/g, such as from 60 to 150 mg KOH/g, such as from 60 to 120 mg KOH/g, such as from 60 to 100 mg KOH/g. The polyester imide polymer may have an acid value of from 65 to 250 mg KOH/g, such as from 65 to 200 mg KOH/g, such as from 65 to 150 mg KOH/g, such as from 65 to 120 mg KOH/g, such as from 65 to 100 mg KOH/g. The polyester imide polymer may have an acid value of from 70 to 250 mg KOH/g, such as from 70 to 200 mg KOH/g, such as from 70 to 150 mg KOH/g, such as from 70 to 120 mg KOH/g, such as from 70 to 100 mg KOH/g. The polyester imide polymer may have an acid value of from 75 to 250 mg KOH/g, such as from 75 to 200 mg KOH/g, such as from 75 to 150 mg KOH/g, such as from 75 to 120 mg KOH/g, such as from 75 to 100 mg KOH/g. The polyester imide polymer may have an acid value of from 80 to 250 mg KOH/g, such as from 80 to 200 mg KOH/g, such as from 80 to 150 mg KOH/g, such as from 80 to 120 mg KOH/g, such as from 80 to 100 mg KOH/g.

The polyester imide polymer may have an acid value from 25 to 150 mg KOH/g.

The polyester imide polymer may have an acid value from 50 to 100 mg KOH/g.

The polyester imide polymer may have an acid value from 75 to 85 mg KOH/g.

The polyester imide polymer may have an acid value of more than 25 mg KOH/g, such as more than 30 mg KOH/g, such as more than 35 mg KOH/g, such as more than 40 mg KOH/g, such as more than 45 mg KOH/g, such as more than 50 mg KOH/g, such as more than 55 mg KOH/g, such as more than 60 mg KOH/g, such as more than 65 mg KOH/g, such as more than 70 mg KOH/g, such as more than 75 mg KOH/g, or even more than 80 mg KOH/g.

The acid value is suitably expressed on solids.

As reported herein, the acid value was determined by titration with 0.1N methanolic potassium hydroxide solution. The sample of polymer (0.1-3 grams depending on acid value) was weighed accurately (on a balance with accuracy to weigh in milligrams) into a conical flask and was then dissolved in 25 millilitres of a solvent mixture containing dichloromethane and ethanol (3/1 w/w) and a few drops of 0.1% solution bromo thymol blue indicator; using light heating and stirring as appropriate. The solution was then cooled to room temperature (20-30° C.) and the solution titrated with the potassium hydroxide solution. The resulting acid value (acid number) is expressed in units of mg KOH/g and is calculated using the following equation.

$$Acid Value = ( titre KOH solution ( mls ) \times Molarity KOH solution \times 56.1 ) /$$

$$Weight of solid sample ( grams )$$

All values for acid value reported herein were measured in this way.

The polyester imide polymer has a hydroxyl value (OHV) of up to 5 mg KOH/g.

The polyester imide polymer may have a hydroxyl value of up to 4 mg KOH/g, such as up to 3 mg KOH/g, such as up to 2 mg KOH/g, such as up to 1 mg KOH/g, or even up to 0.5 mg KOH/g.

The polyester imide polymer may have a hydroxyl value of less than 5 mg KOH/g, such as less than mg KOH/g, such less than 3 mg KOH/g, such as less than 2 mg KOH/g, such as less than 1 mg KOH/g, such as less than 0.5 mg KOH/g.

The polyester imide material may have a hydroxyl value of 0 (zero) mg KOH/g.

The polyester imide polymer may have a hydroxyl value from 0 to 5 mg KOH/g, such as from 0 to 4 mg KOH/g, such as from 0 to 3 mg KOH/g, such as from 0 to 2 mg KOH/g, such as from 0 to 1 mg KOH/g, or even from 0 to 0.5 mg KOH/g.

The hydroxyl value (OHV) is suitably expressed on solids.

As reported herein, the hydroxyl value is the number of mg of KOH equivalent to the hydroxyl groups in 1 g of material. The hydroxyl value may be determined as follows. A sample (typically, 0.1 to 3 g) was weighed accurately into a conical flask and is dissolved, using light heating and stirring as appropriate, in 20 ml of tetrahydrofuran. 10 ml of 0.1M 4-(dimethylamino)pyridine in tetrahydrofuran (catalyst solution) and 5 ml of a 9 vol % solution of acetic anhydride in tetrahydrofuran (i.e. 90 ml acetic anhydride in 910 ml tetrahydrofuran; acetylating solution) were then added to the mixture. After 5 minutes, 10 ml of an 80 vol % solution of tetrahydrofuran (i.e. 4 volume parts tetrahydrofuran to 1 part distilled water; hydrolysis solution) was added. After 15 minutes, 10 ml tetrahydrofuran was added and the solution is titrated with 0.5M ethanolic potassium hydroxide (KOH). A blank sample was also run where the sample of solid polyester is omitted. The resulting net hydroxyl number is expressed in units of mg KOH/g and is calculated using the following equation:

$$Net hydroxyl value = ( ( {V}_{2} - {V}_{1} ) \times molarity of KOH solution ( M ) \times 56.1 ) /$$

$$weight of solid sample ( g )$$

wherein V₁ is the titre of KOH solution (ml) of the polyester sample and V₂ is the titre of KOH solution (ml) of the blank sample.

The hydroxyl value is then calculated by adding the net hydroxyl value, as discussed above, to the acid value of the material (as determined above), as follows:

Net hydroxyl value (mg)+Acid value (mg)=Hydroxyl value (mg)

All values for hydroxyl value reported herein were measured in this way. The hydroxyl value as referenced herein is sometimes referred to in the literature as the “gross hydroxyl value”. Accordingly, for the avoidance of doubt, as referred to herein, unless stated otherwise, the “hydroxyl value” stated is equivalent to the “gross hydroxyl value”.

The polyester imide polymer may have any suitable number-average molecular weight (Mn). The polyester imide polymer may have an Mn from 250 to 200,000 Daltons (Da=g/mole), such as from 500 to 100,000 Da, such as from 750 to 75,000 Da, such as from 1,000 to 50,000 Da, such as from 1,000 to 25,000 Da, such as from 1,000 to 20,000 Da, such as from 1,250 to 10,000 Da, or even from 1,500 to 5,000 Da.

The polyester imide polymer may have an Mn of at least 500 Da, such as at least 750, such as at least 1,000 Da, such as at least 1,250 Da, or even at least 1,500 Da. The polyester imide polymer may have an Mn of up to 200,000 Da, such as up to 100,000 Da, such as up to 75,000 Da, such as up to 50,000 Da, such as up to 25,000 Da, such as up to 20,000 Da, such as up to 10,000 Da, or even up to 5,000 Da. The polyester imide may have an Mn from 500 to 200,000 Da, such as from 750 to 200,000 Da, such as from 1,000 to 200,000 Da, such as from 1,250 to 200,000 Da, such as from 1,500 to 200,000 Da. The polyester imide may have an Mn from 500 to 100,000 Da, such as from 750 to 100,000 Da, such as from 1,000 to 100,000 Da, such as from 1,250 to 100,000 Da, such as from 1,500 to 100,000 Da. The polyester imide may have an Mn from 500 to 50,000 Da, such as from 750 to 50,000 Da, such as from 1,000 to 50,000 Da, such as from 1,250 to 50,000 Da, such as from 1,500 to 50,000 Da. The polyester imide may have an Mn from 500 to 25,000 Da, such as from 750 to 25,000 Da, such as from 1,000 to 25,000 Da, such as from 1,250 to 25,000 Da, such as from 1,500 to 25,000 Da. The polyester imide may have an Mn from 500 to 20,000 Da, such as from 750 to 20,000 Da, such as from 1,000 to 20,000 Da, such as from 1,250 to 20,000 Da, such as from 1,500 to 20,000 Da. The polyester imide may have an Mn from 500 to 10,000 Da, such as from 750 to 10,000 Da, such as from 1,000 to 10,000 Da, such as from 1,250 to 10,000 Da, such as from 1,500 to 10,000 Da. The polyester imide may have an Mn from 500 to 5,000 Da, such as from 750 to 5,000 Da, such as from 1,000 to 5,000 Da, such as from 1,250 to 5,000 Da, such as from 1,500 to 5,000 Da.

As reported herein, the Mn was determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml).

All values for Mn reported herein were measured in this way.

The polyester imide polymer may have any suitable weight-average molecular weight (Mw). The polyester imide polymer may have an Mw from 500 to 200,000 Daltons (Da=g/mole), such as from 1,000 to 100,000 Da, such as from 2,000 to 75,000 Da, such as from 2,500 to 50,000 Da, such as from 5,000 to 40,000 Da or even from 10,000 to 30,000 Da.

The polyester imide polymer may have an Mw of at least 500 Da, such as at least 1,000 Da, such as at least 2,000 Da, such as at least 2,500 Da, such as at least 5,000 Da, or even at least 10,000 Da. The polyester imide polymer may have an Mw of up to 200,000 Da, such as up to 100,000 Da, such as up to 75,000 Da, such as up to 50,000 Da, such as up to 40,000 Da, or even up to 30,000 Da. The polyester imide polymer may have an Mw from 500 to 200,000 Da, such as from 1,000 to 200,000 Da, such as from 2,000 to 200,000 Da, such as from 2,500 to 200,000 Da, such as from 5,000 to 200,000 Da, such as from 10,000 to 200,000 Da. The polyester imide polymer may have an Mw from 500 to 100,000 Da, such as from 1,000 to 100,000 Da, such as from 2,000 to 100,000 Da, such as from 2,500 to 100,000 Da, such as from 5,000 to 100,000 Da, such as from 10,000 to 100,000 Da. The polyester imide polymer may have an Mw from 500 to 75,000 Da, such as from 1,000 to 75,000 Da, such as from 2,000 to 75,000 Da, such as from 2,500 to 75,000 Da, such as from 5,000 to 75,000 Da, such as from 10,000 to 75,000 Da. The polyester imide polymer may have an Mw from 500 to 50,000 Da, such as from 1,000 to 50,000 Da, such as from 2,000 to 50,000 Da, such as from 2,500 to 50,000 Da, such as from 5,000 to 50,000 Da, such as from 10,000 to 50,000 Da. The polyester imide polymer may have an Mw from 500 to 40,000 Da, such as from 1,000 to 40,000 Da, such as from 2,000 to 40,000 Da, such as from 2,500 to 40,000 Da, such as from 5,000 to 40,000 Da, such as from 10,000 to 40,000 Da. The polyester imide polymer may have an Mw from 500 to 30,000 Da, such as from 1,000 to 30,000 Da, such as from 2,000 to 30,000 Da, such as from 2,500 to 30,000 Da, such as from 5,000 to 30,000 Da, such as from 10,000 to 30,000 Da.

As reported herein, the Mw was determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml).

All values for Mw reported herein were measured in this way.

The polyester imide polymer may be in solid form at room temperature and at atmospheric pressure.

The polyester imide polymer may have any suitable glass transition temperature (Tg). The polyester imide polymer may have a Tg from to 5 to 150° C., such as from 10 to 100° C., such as from 15 to 75° C., such as from 20 to 50° C., or even from 25 to 40° C.

The polyester imide polymer may have a Tg of at least 5° C., such as at least 10° C., such as at least 15° C., such as at least 20° C., or even at least 25° C. The polyester imide polymer may have a Tg of up to 150° C. such as up to 100° C. such as up to 75° C., such as up to 50° C., or even up to 40° C. The polyester imide polymer may have a Tg from 5 to 150° C., such as from 5 to 100° C., such as from 5 to 75° C., such as from 5 to 50° C., or even from 5 to 40° C. The polyester imide polymer may have a Tg from 10 to 150° C., such as from 10 to 100° C., such as from 10 to 75° C., such as from 10 to 50° C., or even from 10 to 40° C. The polyester imide polymer may have a Tg from 15 to 150° C., such as from 15 to 100° C., such as from 15 to 75° C., such as from 15 to 50° C., or even from 15 to 40° C. The polyester imide polymer may have a Tg from 20 to 150° C., such as from 20 to 100° C., such as from 20 to 75° C., such as from 20 to 50° C., or even from 20 to 40° C. The polyester imide polymer may have a Tg from 25 to 150° C., such as from 25 to 100° C., such as from 25 to 75° C., such as from 25 to 50° C., or even from 25 to 40° C.

As reported herein, the Tg was measured according to ASTM D6604-00 (2013) (“Standard Practice for Glass Transition Temperatures of Hydrocarbon Resins by Differential Scanning Calorimetry”. Heat-flux differential scanning calorimetry (DSC), sample pans: aluminium, reference: blank, calibration: indium and mercury, sample weight: 10 mg, heating rate: 20° C./min).

All values for Tg reported herein were measured in this way.

The polyester imide polymer may have any suitable viscosity at 180° C. The polyester imide polymer may have a viscosity at 180° C. from 2 to 500 Poise, such as from 10 to 400 Poise, such as from 20 to 300 Poise, such as from 30 to 250 Poise, such as from 40 to 200 Poise, or even from 50 to 150 Poise.

The polyester imide polymer may have a viscosity of 180° C. of at least 2 Poise, such as at least 10 Poise, such as at least 20 Poise, such as at least 30 Poise, such as at least 40 Poise, or at least 50 Poise. The polyester imide polymer may have a viscosity at 180° C. of up to 500 Poise, such as up to 400 Poise, such as up to 300 Poise, such as up to 250 Poise, such as up to 200 Poise, or even up to 150 Poise. The polyester imide polymer may have a viscosity from 2 to 500 Poise, such as from 2 to 400 Poise, such as from 2 to 300 Poise, such as from 2 to 250 Poise, such as from 2 to 200 Poise, or even from 2 to 150 Poise. The polyester imide polymer may have a viscosity from 10 to 500 Poise, such as from 10 to 400 Poise, such as from 10 to 300 Poise, such as from 10 to 250 Poise, such as from 10 to 200 Poise, or even from 10 to 150 Poise. The polyester imide polymer may have a viscosity from 20 to 500 Poise, such as from 20 to 400 Poise, such as from 20 to 300 Poise, such as from 20 to 250 Poise, such as from 20 to 200 Poise, or even from 20 to 150 Poise. The polyester imide polymer may have a viscosity from 30 to 500 Poise, such as from 30 to 400 Poise, such as from 30 to 300 Poise, such as from 30 to 250 Poise, such as from 30 to 200 Poise, or even from 30 to 150 Poise. The polyester imide polymer may have a viscosity from 40 to 500 Poise, such as from 40 to 400 Poise, such as from 40 to 300 Poise, such as from 40 to 250 Poise, such as from 40 to 200 Poise, or even from 40 to 150 Poise. The polyester imide polymer may have a viscosity from 50 to 500 Poise, such as from 50 to 400 Poise, such as from 50 to 300 Poise, such as from 50 to 250 Poise, such as from 50 to 200 Poise, or even from 50 to 150 Poise.

As reported herein, the melt viscosity was determined using a cone and plate viscometer with a heated plate with cones which can be selected together with appropriate rotational speeds to measure viscosities within the desired ranges. In this work, the cone and plate viscometer used was a Brookfield CAP 2000+ machine which is capable of measuring viscosities at temperatures 100-250° C. The temperature selected for the measurement was held constant throughout the measurement time and the detail of the temperature used is recorded in each example. The cone used was a spindle number 6 and the speed of rotation was selected to ensure that the range of measurements fell well within the total measurement range.

All values for melt viscosity reported herein were measured this way.

The coating compositions may comprise any suitable amount of polyester imide polymer. The coating composition may comprise from 10 to 99.9 wt %, such as from 25 to 99 wt %, such as from 50 to 99 wt %, such as from 60 to 95 wt %, or even from 65 to 90 wt % of the polyester imide polymer based on the total solid weight of the coating composition.

The coating compositions may comprise at least 10 wt %, such as at least 25 wt %, such as at least 50 wt %, such as at least 60 wt %, or even at least 65 wt % of the polyester imide polymer based on the total solid weight of the coating composition. The coating compositions may comprise up to 99.9 wt %, such as up to 99 wt %, such as up to 95 wt %, or even up to 90 wt % of the polyester imide polymer based on the total solid weight of the coating composition. The coating composition may comprise from 10 to 99.9 wt %, such as from 25 to 99.9 wt %, such as from 50 to 99.9 wt %, such as from 60 to 99.9 wt %, or even from 65 to 99.9 wt % of the polyester imide polymer based on the total solid weight of the coating composition. The coating composition may comprise from 10 to 99 wt %, such as from 25 to 99 wt %, such as from 50 to 99 wt %, such as from 60 to 99 wt %, or even from 65 to 99 wt % of the polyester imide polymer based on the total solid weight of the coating composition. The coating composition may comprise from 10 to 95 wt %, such as from 25 to 95 wt %, such as from 50 to 95 wt %, such as from 60 to 95 wt %, or even from 65 to 95 wt % of the polyester imide polymer based on the total solid weight of the coating composition. The coating composition may comprise from 10 to 90 wt %, such as from 25 to 90 wt %, such as from 50 to 90 wt %, such as from 60 to 90 wt %, or even from 65 to 90 wt % of the polyester imide polymer based on the total solid weight of the coating composition.

The coating composition may comprise from 60 to 90 wt % of the polyester imide based on the total solid weight of the coating composition.

The coating composition comprises a crosslinker material operable to crosslink the acid functionality of the polyester imide polymer. The coating composition may comprise any suitable crosslinker material operable to crosslink the acid functionality of the polyester imide polymer. Suitable crosslinker materials will be well known to the person skilled in the art.

The crosslinker material may be a single molecule, a dimer, an oligomer, a (co)polymer or a mixture thereof. The crosslinker material may be a dimer or trimer.

Suitable crosslinker materials include, but are not limited to: phenolic resins (or phenol-formaldehyde resins); aminoplast resins (ortriazine-formaldehyde resins); amino resins; epoxy resins; epoxy-mimic resins, such as those based on bisphenol A (BPA) replacements; isocyanate resins; isocyanurate resins, such as triglycidylisocyanurate; hydroxy (alkyl) amide resins, such as β-hydroxy (alkyl) amide resins and polyhydroxyalkylamide materials; hydroxy(alkyl) urea resins; carbodiimide resins; oxazolines; polyamines; polyamides; silanes; silane end-capped polymers; polysiloxanes, such as hydroxyl-functionalised polysiloxanes; polybutadienes; polycaprolactones; polyether polyols; and combinations thereof.

The crosslinker material may comprise isocyanate resins, hydroxy (alkyl) amide resins, such as β-hydroxy (alkyl) amide resins and polyhydroxyalkylamide materials, hydroxy(alkyl) urea resins, carbodiimide resins, oxazolines, silanes; silane end-capped polymers; polysiloxanes, such as hydroxyl-functionalised polysiloxanes, polybutadienes, polycaprolactones, polyether polyols or combinations thereof.

The crosslinker material may comprise isocyanate resins, hydroxy (alkyl) amide resins, such as β-hydroxy (alkyl) amide resins and polyhydroxyalkylamide materials, silanes; silane end-capped polymers; polysiloxanes, such as hydroxyl-functionalised polysiloxanes, polybutadienes, polycaprolactones or combinations thereof.

Suitable examples of phenolic resins are those formed from the reaction of a phenol with an aldehyde or a ketone, such as from the reaction of a phenol with an aldehyde, such as from the reaction of a phenol with formaldehyde or acetaldehyde, or even from the reaction of a phenol with formaldehyde. Non-limiting examples of phenols which may be used to form phenolic resins are phenol, butyl phenol, xylenol and cresol. General preparation of phenolic resins is described in “The Chemistry and Application of Phenolic Resins or Phenoplasts”, Vol V, Part I, edited by Dr Oldring; John Wiley and Sons/Cita Technology Limited, London, 1997. The phenolic resins may be of the resol type. By “resol type” we mean resins formed in the presence of a basic (alkaline) catalyst and optionally an excess of formaldehyde. Suitable examples of commercially available phenolic resins include, but are not limited to those sold under the trade name PHENODUR® commercially available from Allnex, such as PHENODUR EK-827, PHENODUR VPR1785, PHENODUR PR 515, PHENODUR PR516, PHENODUR PR 517, PHENODUR PR 285, PHENODUR PR612 or PHENODUR PH2024; resins sold under the trade name BAKELITE® commercially available from Sumitomo Bakelite co., ltd., such as BAKELITE 6582 LB, BAKELITE 6535, BAKELITE PF9989 or BAKELITE PF6581; SFC 112 commercially available from SI Group; DUREZ® 33356 commercially available from SHHPP; ARALINK® 40-852 commercially available from Bitrez; or combinations thereof.

Suitable examples of isocyanate resins include, but are not limited to the following: isophorone diisocyanate (IPDI), such as those sold under the trade name DESMODUR® commercially available from Covestro, for example DESMODUR VP-LS 2078/2, DESMODUR BL 3370, DESMODUR Z 4470, DESMODUR 2078/2 or DESMODUR PL 340 or those sold under the trade name VESTANAT® commercially available from Evonik, for example VESTANANT B 1370, VESTANAT B 118 6A, VESTANAT B 1042 E, VESTANAT T 1890/100 or VESTANAT B 1358 A; blocked aliphatic polyisocyanate based on hexamethylene diisocyanate (HDI), such as those sold under the trade name DESMODUR® commercially available from Covestro, for example DESMODUR BL3370, DESMODUR BL 3175 SN, DESMODUR PL3370, DESMODUR PL350 or DESMODUR PL340, those sold under the trade name DURANATE® commercially available from Asahi KASEI, for example DURANATE MF-K60X, those sold under the trade name TOLONATE® commercially available from Vencorex Chemicals, for example TOLONATE 02 or those sold under the trade name TRIXENE® commercially available from Baxenden, for example TRIXENE-BI-7984, TRIXENE-BI-7963 or TRIXENE 7981; those sold under the trade name VESTAGON® commercially available from Evonik, for example VESTAGON EP-B 1190; or combinations thereof.

The crosslinker material may contain nitrogen. The crosslinker material may be in the form of an amine or amide material. The crosslinker material may comprise a hydroxyl substituted amine or amide material.

The crosslinker material may comprise a hydroxyalkylamide material, such as a β-hydroxyalkylamide material.

The crosslinker material may contain a terminal chemical group as shown in Formula I.

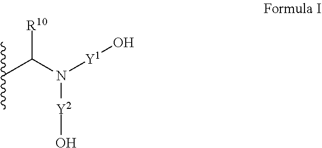

wherein R¹⁰ represents an electron withdrawing group, such as (═O); and
Y¹ and Y² each, independently, represents a C₁ to C₃ alkylene group.

The terminal chemical group of Formula I may be connected to a further chemical structure, not shown. Additionally or alternatively, the chemical group of formula I may be suspended from a carrier substrate, such as a silica carrier substrate, for example.

The crosslinker material may contain a plurality of terminal chemical groups as shown in Formula I. For example, the crosslinker material may contain 2, 3 or 4 terminal chemical groups as shown in Formula I.

The crosslinker material may comprise a moiety according to Formula II:

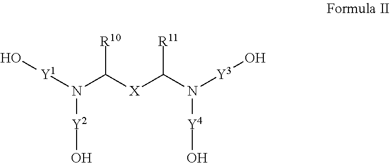

wherein R¹⁰ and R¹¹ each, independently, represent an electron withdrawing group, such as (═O); Y¹, Y², Y³ and Y⁴ each, independently, represent a C₁ to C₃ alkylene group; and X represents a C₂ to C₆ alkylene group.

Each of R¹⁰ and R¹¹ may represent a (═O) group.

Each of Y¹, Y², Y³ and Y⁴ may represent an ethylene group.

X may represent a butylene group.

Accordingly, the crosslinker material may comprise a material of formula III:

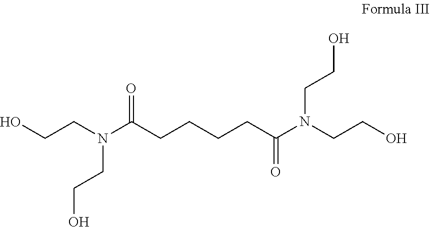 [SMILES: O=C(CCCCC(=O)N(CCO)CCO)N(CCO)CCO]

The crosslinker material may comprise a commercially available β-hydroxyalkylamide crosslinker material, such as, for example, PRIMID XL-552 (available from EMS); PRIMID QM-1260 (available from EMS Chemie); PRIMID SF-4510 (available from EMS Chemie); PROSID 411 (available from Sir Industriale); and N,N,N′,N′-tetrakis(2-hydroxypropyl)adipamide.

The hydroxyalkylamide crosslinker may comprise a polyhydroxyalkylamide material having the formula (IV):

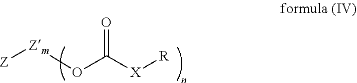

wherein, with reference to formula (IV), Z represents a polymer or an alkylene, alkenylene, alkynylene or arylene group; Z′ represents a bivalent organic linking group; m is 0 or 1; X represents a bivalent organic bridging group; R represents a hydroxyalkylamide group; and n is at least 2.

Further details of suitable hydroxy functional alkyl polyurea materials are disclosed in PCT patent application WO 2020/123893.

The hydroxy functional alkyl polyurea material may comprise a material having the formula:

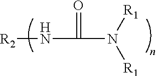

wherein R₂ is a substituted or unsubstituted C₁ to C₃₆ alkyl group, an aromatic group, an isocyanurate moiety, biuret moiety, allophonate moiety, glycoluril moiety, benzoguanamine moiety, polyetheramine moiety, and/or polymeric moiety different from a polyetheramine and having an Mn of 500 or greater; wherein each R₁ is independently a hydrogen, an alkyl having a carbon, or a hydroxy functional alkyl having 2 or more carbons and at least one R1 is a hydroxyl functional alkyl having 2 or more carbons; and n is 2-6.

Further details of suitable hydroxy functional alkyl polyurea materials are disclosed in PCT patent application WO 2017/123955.

The crosslinker material may be in the form of a carbodiimide resin. The crosslinker material may comprise a polycarbodiimide. The crosslinker material may comprise a polycarbodiimide having the following structural units (XVII) or (XVIII) including mixtures thereof:

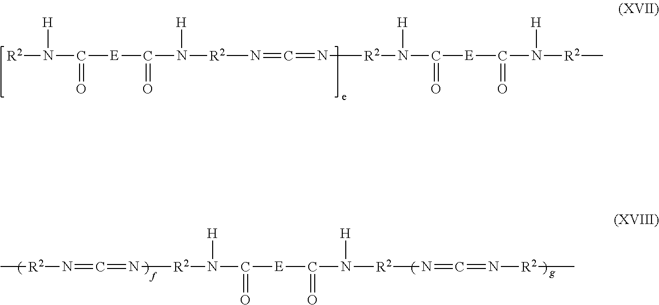

where e is an integer of from 2 to 20; f and g are each at least 1, and f+g is an integer up to 20; E is a radical selected from

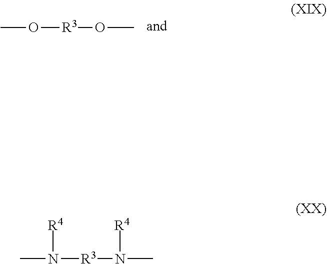

where R² with reference to structural units (XVII) or (XVIII) comprises a cyclic radical and R³ with reference to (XIX) or (XX) is a linear hydrocarbon radical containing at least 4 carbon atoms and R⁴ with reference to (XX) is hydrogen or an alkyl radical.

Further details of suitable carbodiimide resins are disclosed in PCT patent application WO 2017/122171.

The crosslinker material may comprise a silane such as, for example, those sold under the trade name Geniosil® commercially available from Wacker AG, for example Geniosil GF 93, Geniosil GF 94, Geniosil GF 56, Geniosil GF 91, Geniosil GF 31, Geniosil GF 32 or Geniosil GF 96 or tetraethyl orthosilicate.

The crosslinker material may comprise a silane end-capped polymer such as, for example, those sold under the trade name VESTANANT® commercially available from Evonik, for example, VESTANANT EP-M 60 or VESTANANT EP-M 222.

The crosslinker material may comprise a hydroxyl-functionalised polysiloxanes such as, for example, those sold under the trade name Dowsil® commercially available from Dow, for example Dowsil RSN-0255 or Dowsil RSN-0233.

The crosslinker material may comprise polybutadiene, such as, for example, Poly BD HTLP R45 (available from Cray Valley), Poly BD 7001 (available from Cray Valley), Poly BD 700S (available from Cray Valley), Poly BD 605E (available from Cray Valley), Krasol F3000 (available from Cray Valley and/or PB 3600-ID-901 (available from DAICEL Corp.).

The crosslinker material may comprise polycaprolactone such as, for example, those sold under the trade name Capa® commercially available from Ingevity, such as Capa 3091, Capa 3022, Capa 3031, Capa 2043, Capa 3050 or Capa 4104.

The crosslinker material may comprise a polyether polyol such as, for example, those sold under the trade name Desmophen® commercially available from Covestro, such as Desmophen 2060 BD, Desmophen 1110 BD or Desmophen 1400 BT.

The crosslinker material may be present in the coating composition in any suitable amount.

The coating compositions may comprise any suitable amount of crosslinker material. The coating compositions may comprise from 0.1 to 90 wt %, such as from 0.5 to 80 wt %, such as from 1 to 70 wt %, such as from 5 to 60 wt %, such as from 10 to 50 wt %, or even from 10 to 40 wt % of the crosslinker material based on the total solid weight of the coating composition.

The coating composition may comprise at least 0.1 wt %, such as at least 0.5 wt %, such as at least 1 wt %, such as at least 5 wt %, or even at least 10 wt % of the crosslinker material based on the total solid weight of the coating composition. The coating composition may comprise up to 90 wt %, such as up to 80 wt %, such as up to 70 wt %, such as up to 60 wt %, such as up to 50 wt %, or even up to 40 wt % of the crosslinker material based on the total solid weight of the coating composition. The coating composition may comprise from 0.1 to 90 wt %, such as from 0.5 to 90 wt %, such as from 1 to 90 wt %, such as from 5 to 90 wt %, or even from 10 to 90 wt % of the crosslinker material based on the total solid weight of the coating composition. The coating composition may comprise from 0.1 to 80 wt %, such as from 0.5 to 80 wt %, such as from 1 to 80 wt %, such as from 5 to 80 wt %, or even from 10 to 80 wt % of the crosslinker material based on the total solid weight of the coating composition. The coating composition may comprise from 0.1 to 70 wt %, such as from 0.5 to 70 wt %, such as from 1 to 70 wt %, such as from 5 to 70 wt %, or even from 10 to 70 wt % of the crosslinker material based on the total solid weight of the coating composition. The coating composition may comprise from 0.1 to 60 wt %, such as from 0.5 to 60 wt %, such as from 1 to 60 wt %, such as from 5 to 60 wt %, or even from 10 to 60 wt % of the crosslinker material based on the total solid weight of the coating composition. The coating composition may comprise from 0.1 to 50 wt %, such as from 0.5 to 50 wt %, such as from 1 to 50 wt %, such as from 5 to 50 wt %, or even from 10 to 50 wt % of the crosslinker material based on the total solid weight of the coating composition. The coating composition may comprise from 0.1 to 40 wt %, such as from 0.5 to 40 wt %, such as from 1 to 40 wt %, such as from 5 to 40 wt %, or even from 10 to 40 wt % of the crosslinker material based on the total solid weight of the coating composition.

The coating composition may comprise from 10 to 40 wt % of the crosslinker material based on the total solid weight of the coating composition.

The coating composition may comprise any suitable weight ratio of polyester imide polymer (a) to crosslinker material (b). The coating composition may have a weight ratio of (a) to (b) from to 50:1 to 1:10, such as from 40:1 to 1:5, such as from 30:1 to 1:1, such as from 20:1 to 2:1, such as from 10:1 to 2.5:1, or even from 5:1 to 2.5:1.

The coating composition may have a weight ratio of (a) to (b) of at least 1:10, such as at least 1:5, such as at least 1:1, such as at least 2:1, or even at least 2.5:1. The coating composition may have a weight ratio of (a) to (b) of up to 50:1, such as up to 40:1, such as up to 30:1, such as up to 20:1, such as up to 10:1, or even up to 5:1. The coating composition may have a weight ratio of (a) to (b) from 50:1 to 1:10, such as from 50:1 to 1:5, such as from 50:1 to 1:1, such as from 50:1 to 2:1, such as from 50:1 to 2.5:1. The coating composition may have a weight ratio of (a) to (b) from 40:1 to 1:10, such as from 40:1 to 1:5, such as from 40:1 to 1:1, such as from 40:1 to 2:1, such as from 40:1 to 2.5:1. The coating composition may have a weight ratio of (a) to (b) from 30:1 to 1:10, such as from 30:1 to 1:5, such as from 30:1 to 1:1, such as from 30:1 to 2:1, such as from 30:1 to 2.5:1. The coating composition may have a weight ratio of (a) to (b) from 20:1 to 1:10, such as from 20:1 to 1:5, such as from 20:1 to 1:1, such as from 20:1 to 2:1, such as from 20:1 to 2.5:1. The coating composition may have a weight ratio of (a) to (b) from 10:1 to 1:10, such as from 10:1 to 1:5, such as from 10:1 to 1:1, such as from 10:1 to 2:1, such as from 10:1 to 2.5:1. The coating composition may have a weight ratio of (a) to (b) from 5:1 to 1:10, such as from 5:1 to 1:5, such as from 5:1 to 1:1, such as from 5:1 to 2:1, such as from 5:1 to 2.5:1.

The coating composition may be a powder composition or a liquid composition.

When the composition is a liquid composition, the coating composition may comprise a solvent and/or carrier. When the composition is a liquid composition, the coating composition may comprise a powder in a liquid carrier. The powder in a liquid carried may be in the form of a dispersion or slurry, for example.

The coating composition may comprise a single solvent/carrier or a mixture of solvents/carriers. The solvent/carrier may comprise water, an organic solvent/carrier, a mixture of water and an organic solvent/carrier or a mixture of organic solvents/carriers.

The organic solvent/carrier suitably has sufficient volatility to essentially entirely evaporate from the coating composition during the curing process. As a non-limiting example, the curing process may be by heating at 130-300° C. for 1-15 minutes.

Suitable organic solvents/carriers include, but are not limited to the following: aliphatic hydrocarbons such as mineral spirits and high flash point naphtha; aromatic hydrocarbons such as benzene; toluene; xylene; solvent naphtha 100, 150, 200; those available from Exxon-Mobil Chemical Company under the SOLVESSO trade name; alcohols such as ethanol; n-propanol; isopropanol; methoxy propanol; and n-butanol; ketones such as acetone; cyclohexanone; methylisobutyl ketone; methyl ethyl ketone; esters such as ethyl acetate; butyl acetate; n-hexyl acetate; dibasic esters; butoxyl; glycols such as butyl glycol; glycol ethers such as 1-methoxypropanol; ethylene glycol monomethyl ether; ethylene glycol monobutyl ether; benzyl alcohol mixed with xylene; benzyl acetate; ethyl lactate; n-butyl pyrrolidone and combinations thereof. The solvent/carrier, when present, may be used in the coating composition in amounts from 10 to 90 wt %, such as from 20 to 80 wt %, such as from 30 to 70 wt %, such as from 30 to 60 wt %, or even from 30 to 50 wt % based on the total weight of the coating composition.

Coating compositions known in the art and used to coat cans, particularly an internal portion thereof may include polyamide imide which is made in N-methyl pyrrolidone. However, N-methyl pyrrolidone has recently been reclassified as toxic to reproduction and development (reprotoxic) and also listed as having specific organ toxicity for the respiratory tract and thus its use is not desirable. Therefore, the coating composition suitably does not include N-methyl pyrrolidone. Suitably, the polyester imide polymer is not formed in the presence of N-methyl pyrrolidone.

The coating composition may be a powder coating composition.

The coating composition may be a thermoset powder coating composition.

The powder coating composition, such as thermoset powder coating composition, may have any suitable average particle size. The powder coating composition, such as thermoset powder coating composition, may have an average particle size from 10 to 1,000 microns (μm), such as from 10 to 500 μm, such as from 10 to 250 μm, or even from 10 to 100 μm. Particles having these sizes may be produced by any suitable method. Suitable methods will be well known to a person skilled in the art. Examples of suitable methods include, but are not limited to, cold grinding and sieving methods.

The average particle size is a D50 value, being the median value that splits the distribution with half above and half below this size. This value is based on volume and sometimes referred to as Dv50.

The composition may comprise titanate material. The titanate material may comprise organic titanate material, such as titanate substituted with organic groups (such as one, two, three or four organic groups). Each organic group in this context may include a substituted or unsubstituted, linear, cyclic or branched C₁ to C₁₂ alkyl, alkenyl, or aryl group.

The titanate material may comprise titanate substituted with organic groups (such as one, two, three or four organic groups), each independently selected from methyl, ethyl, n-propyl, isopropyl, n-butyl, t-butyl, pentyl, hexyl, cyclohexyl.

The titanate material may be selected from the group consisting of tetra n-butyl titanate; tetra iso-propyl titanate; tetra ethyl hexyl titanate; zinc acetate; di butyl tin oxide; butyl stannoic acid; or combinations thereof.

The titanate material may be present in the coating composition in an amount of at least 0.1 wt %, such as at least 0.5 wt %, or even at least 1 wt % based on the total solid weight of the coating composition

The titanate material may be present in the coating composition in an amount of up to than 25 wt %, such as up to 15 wt %, such as up to 10 wt %, or even up to 5 wt % based on the total solid weight of the coating composition.

The titanate material may be present in the coating composition in an amount of from 0.1 to 10 wt %, such as from 0.5 to 6 wt %, or even from 1 to 5 wt % based on the total solid weight of the coating composition.

Where the coating composition is a solid material, such as a powder coating composition, for example, the titanate material may be added to the polyester imide material in a solvent, then the resulting component dried, thereby capturing the titanate material in the solid coating composition.

The coating compositions may further comprise a catalyst. Any catalyst typically used to catalyse crosslinking reactions between acrylic materials and crosslinking agents may be used. Suitable catalysts will be well known to the person skilled in the art. The catalyst may be a non-metal or a metal catalyst or a combination thereof. Suitable non-metal catalysts include, but are not limited to the following: phosphoric acid; blocked phosphoric acid; phosphatised resins such as, for example, phosphatised epoxy resins and phosphatised acrylic resins; CYCAT® XK 406 N (commercially available from Allnex); sulfuric acid; sulfonic acid; CYCAT 600 (commercially available from Allnex); NACURE® 5076 or NACURE 5925 (commercially available from King industries); acid phosphate catalyst such as NACURE XC 235 (commercially available from King Industries); and combinations thereof. Suitable metal catalysts will be well known to the person skilled in the art. Suitable metal catalysts include, but are not limited to the following: tin containing catalysts, such as monobutyl tin tris (2-ethylhexanoate); zirconium containing catalysts, such as KKAT® 4205 (commercially available from King Industries); titanate based catalysts, such as tetrabutyl titanate TnBT (commercially available from Sigma Aldrich); and combinations thereof.

The catalyst, when present, may be used in the coating composition in any suitable amount. The catalyst, when present, may be used in amounts from 0.001 to 10 wt %.

The coating compositions may comprise a further resin material. Suitable further resin materials will be well known to a person skilled in the art. Suitable examples of further resin materials include, but are not limited to the following: polyester resins; acrylic resins; polyvinyl chloride (PVC) resins; alkyd resins; polyurethane resins; polysiloxane resins; epoxy resins or combinations thereof.

The coating compositions may comprise other optional materials well known in the art of formulating coatings, such as colorants, plasticizers, abrasion-resistant particles, anti-oxidants, hindered amine light stabilizers, UV light absorbers and stabilizers, surfactants, flow control agents, thixotropic agents, fillers, organic co-solvents, reactive diluents, catalysts, grind vehicles, lubricants, waxes and other customary auxiliaries.

As used herein, the term “colorant” means any substance that imparts colour and/or other opacity and/or other visual effect to the composition. The colorant can be added to the coating composition in any suitable form, such as discrete particles, dispersions, solutions and/or flakes. A single colorant or a mixture of two or more colorants can be used in the coatings of the present invention. Suitable colorants are listed in U.S. Pat. No. 8,614,286, column 7, line 2 through column 8, line 65, which is incorporated by reference herein. Suitable for packaging coatings include those approved for food contact, such as titanium dioxide; iron oxides, such as black iron oxide; aluminium paste; aluminium powder such as aluminium flake; carbon black; ultramarine blue; phthalocyanines, such as phthalocyanine blue and phthalocyanine green; chromium oxides, such as chromium green oxide; graphite fibrils; ferried yellow; quindo red; and combinations thereof, and those listed in Article 178.3297 of the Code of Federal Regulations, which is incorporated by reference herein.

The colorant, when present, may be used in the coating composition in any suitable amount. The colorant, when present, may be used in the coating composition in amounts up to 90 wt %, such as up to 50 wt %, or even up to 10 wt % based on the total solid weight of the coating composition.

Suitable lubricants will be well known to the person skilled in the art. Suitable examples of lubricants include, but are not limited to the following: carnauba wax and polyethylene type lubricants. The lubricant, when present, may be used in the coating composition in amounts of at least 0.01 wt % based on the total solid weight of the coating composition.

Surfactants may optionally be added to the coating composition in order to aid in flow and wetting of the substrate. Suitable surfactants will be well known to the person skilled in the art. The surfactant, when present, may be chosen to be compatible with food and/or beverage container applications or aerosol applications, such as aerosol applications. Suitable surfactants include, but are not limited to the following: alkyl sulphates (e.g., sodium lauryl sulphate); ether sulphates; phosphate esters; sulphonates; and their various alkali, ammonium, amine salts; aliphatic alcohol ethoxylates; alkyl phenol ethoxylates (e.g. nonyl phenol polyether); salts and/or combinations thereof. The surfactants, when present, may be present in amounts from 0.01 wt % to 10 wt %, such as from 0.01 to 5 wt %, such as from 0.01 to 2 wt % based on the total solid weight of the coating composition.

Many coating compositions currently used for food and/or beverage or aerosol applications contain epoxy resins. Such epoxy resins are typically formed from polyglycidyl ethers of bisphenol A (BPA). BPA is perceived as being harmful to human health and it is therefore desirable to eliminate it from coatings. Derivatives of BPA such as diglycidyl ethers of bisphenol A (BADGE), epoxy novolak resins and polyols prepared from BPA and bisphenol F (BPF) are also viewed as problematic.

The coating compositions are substantially free of bisphenol A (BPA) and derivatives thereof. The coating compositions may be essentially free or may be completely free of bisphenol A (BPA) and derivatives thereof. Derivatives of bisphenol A include, for example, bisphenol A diglycidyl ether (BADGE). The coating compositions according to the present invention are also substantially free of bisphenol F (BBF) and derivatives thereof. The coating compositions may be essentially free or may be completely free of bisphenol F (BPF) and derivatives thereof. Derivatives of bisphenol F include, for example, bisphenol F diglycidyl ether (BPFG). The compounds or derivatives thereof mentioned above may not be added to the composition intentionally but may be present in trace amounts because of unavoidable contamination from the environment. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating compositions may be substantially free, essentially free or may be completely free of dialkyltin compounds, including oxides or other derivatives thereof. Examples of dialkyltin compounds include, but are not limited to the following: dibutyltindilaurate (DBTDL); dioctyltindilaurate; dimethyltin oxide; diethyltin oxide; dipropyltin oxide; dibutyltin oxide (DBTO); dioctyltinoxide (DOTO) or combinations thereof. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating compositions may be substantially free, may be essentially free or may be completely free of bromine. By “substantially free” we mean to refer to coating compositions containing less than 1000 parts per million (ppm) of bromine. By “essentially free” we mean to refer to coating compositions containing less than 100 ppm of bromine. By “completely free” we mean to refer to coating compositions containing less than 20 parts per billion (ppb) of bromine.

The coating compositions may be prepared by any suitable method. For example, the coating compositions may be prepared by first dry blending the polyester imide polymer, the crosslinker material and, if present, pigment and/or filler, curing agent and additives in a blender. The blender may be operated for any suitable period of time. The blender may be operated for a period of time sufficient to result in a homogeneous dry blend of the materials charged thereto. The homogenous dry blend may then be melt blended in an extruder, such as a twin-screw co-rotating extruder, operated within a temperature range from 80 to 140° C., such as from 100 to 125° C. The extrudate of the coating composition may be cooled and is typically milled to an average particle size as described above.

The coating composition may be a curable coating composition. “Curable coating compositions” and like terms as used herein, refers to coating compositions that have an initial powder state and a final state in which the coating composition has been transformed into a substantially continuous, coalesced state.

Thus, there is provided a method of making a metal package having a coating on at least a portion thereof, the method comprising:
i) applying a coating composition according to the present invention to at least a portion of the metal package; and
ii) curing the coating composition to form a coating.

The coating composition may be cured by any suitable method. The coating composition may be cured by heat curing or by chemical curing.

The coating composition may be cured by heat curing. The coating composition, when heat cured, may be cured at any suitable temperature. The coating composition, when heat cured, may be cured at temperatures from 50 to 350° C., such as from 100 to 320° C., such as from 120 to 300° C., such as from 150 to 250° C., such as from 150 to 200° C., or even from 180 to 200° C.

The coating composition may be cured at a temperature from 150 to 250° C.

The coating composition may be cured at a temperature from 180 to 250° C.

The coating composition may be cured at a temperature from 150 to 200° C.

The coating composition may be cured at a temperature from 180 to 200° C.

Advantageously, the coating compositions of the present invention may be cured at lower temperatures than would typically be expected.

The coating compositions may be applied to a substrate, or a portion thereof, as a single layer or as part of a multi layer system. The coating composition may be applied as a single layer. The coating compositions may be applied to an uncoated substrate. For the avoidance of doubt an uncoated substrate extends to a surface that is cleaned prior to application. The coating compositions may be applied on top of another paint layer as part of a multi layer system. For example, the coating composition may be applied on top of a primer. The coating compositions may form an intermediate layer or a top coat layer. The coating composition may be applied as the first coat of a multi coat system. The second, third, fourth etc. coats may comprise any suitable paint such as those containing, for example, epoxy resins; polyester resins; polyurethane resins; polysiloxane resins; hydrocarbon resins or combinations thereof. The second, third, fourth etc. coats may comprise polyester resins. The second, third, fourth etc. coats may be a liquid coating or a powder coating, such as a powder coating.

The coating compositions may be applied on top of a primer.

The coating compositions may be applied to a substrate once or multiple times.

The coating compositions may be applied to any suitable substrate. The substrate may be formed of metal, plastic, composite and/or wood. The substrate may be a metal substrate.

Suitable metals include, but are not limited to, the following: steel; tinplate; tinplate pre-treated with a protective material such as chromium, titanium, titanate or aluminium; tin-free steel (TFS); galvanised steel, such as for example electro-galvanised steel; aluminium; aluminium alloy; and combinations thereof.

The metal may be aluminium, aluminium alloy, or combinations thereof.

Examples of suitable metal substrates include, but are not limited to, food and/or beverage packaging, components used to fabricate such packaging or monobloc aerosol cans and/or tubes.

The food and/or beverage packaging may be a can. Examples of cans include, but are not limited to, two-piece cans, three-piece cans and the like. Suitable examples of monobloc aerosol cans and/or tubes include, but are not limited to, deodorant and hair spray containers. Monobloc aerosol cans and/or tubes may be aluminium monobloc aerosol cans and/or tubes.

The substrate may be a food and/or beverage packaging or component used to fabricate such packaging.

The substrate may be a monobloc aerosol can and/or tube.

The application of various pre-treatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. For example, when the contents of the can are acidic in nature. The coatings applied to the interior of metal cans also help prevent corrosion in the headspace of the cans, which is the area between the fill line of the product and the can lid; corrosion in the headspace is particularly problematic with food products having a high salt content. Coatings can also be applied to the exterior of metal cans.

The coating compositions may be applied to coiled metal stock, such as the coiled metal stock from which the ends of cans are made (“can end stock”), and end caps and closures are made (“cap/closure stock”). Since coatings designed for use on can end stock and cap/closure stock are typically applied prior to the piece being cut and stamped out of the coiled metal stock, they are typically flexible and extensible. For example, such stock is typically coated on both sides. Thereafter, the coated metal stock is punched. For can ends, the metal is then scored for the “pop-top” opening and the pop-top ring is then attached with a pin that is separately fabricated. The end is then attached to the can body by an edge rolling process. A similar procedure is done for “easy open” can ends. For easy open can ends, a score substantially around the perimeter of the lid allows for easy opening or removing of the lid from the can, typically by means of a pull tab. For caps and closures, the cap/closure stock is typically coated, such as by roll coating, and the cap or closure stamped out of the stock; it is possible, however, to coat the cap/closure after formation. Coatings for cans subjected to relatively stringent temperature and/or pressure requirements should also be resistant to popping, corrosion, blushing and/or blistering.

The substrate may be a package coated at least in part with any of the coating compositions described herein. A “package” is anything used to contain another item, such as for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which typically ranges from several months to years. Thus, the present “package” is distinguished from a storage container or bakeware in which a consumer might make and/or store food; such a container would only maintain the freshness or integrity of the food item for a relatively short period. A package according to the present invention can be made of metal or non-metal, for example, plastic or laminate, and be in any form. An example of a suitable package is a laminate tube. Another example of a suitable package is metal can. The term “metal can” includes any type of metal can, container or any type of receptacle or portion thereof that is sealed by the food and/or beverage manufacturer to minimize or eliminate spoilage of the contents until such package is opened by the consumer. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends” including “E-Z open ends”, which are typically stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present invention can also include plastic bottles, plastic tubes, laminates and flexible packaging, such as those made from PE, PP, PET and the like. Such packaging could hold, for example, food, toothpaste, personal care products and the like.

The coating compositions can be applied to the interior and/or the exterior of the package. The coating compositions could also be applied as a rim coat to the bottom of the can. The rim coat functions to reduce friction for improved handling during the continued fabrication and/or processing of the can. The coating compositions can also be applied to caps and/or closures; such application can include, for example, a protective varnish that is applied before and/or after formation of the cap/closure and/or a pigmented enamel post applied to the cap, such as those having a scored seam at the bottom of the cap. Decorated can stock can also be partially coated externally with the coating described herein, and the decorated, coated can stock used to form various metal cans.

Metal coils, having wide application in many industries, are also substrates that can be coated according to the present invention. Coil coatings also typically comprise a colorant.

The coating compositions of the present invention may be applied to at least a portion of the substrate. For example, when the coating compositions are applied to a food and/or beverage can, the coating compositions may be applied to at least a portion of an internal and/or external surface of said food and/or beverage can. For example, when the coating compositions are applied to a food and/or beverage can, the coating compositions may be applied to at least a portion of an internal surface of said food and/or beverage can.

The coating composition may be applied as a repair coating for component parts of food and beverage cans. For example, as a repair coating for a full aperture easy open end for food cans. This end component may repair coated, after fabrication, by airless spraying of the material on to the exterior of the score line. Other uses as repair coatings include the coating of seams and welds, such as side seams for which the coating may be applied to the area by spraying (airless or air driven) or roller coating. Repair coating can also include protection of vulnerable areas where corrosion may be likely due to damage, these areas include flanges, rims and bottom rims where the coating may be applied by spraying, roller coating flow or dip coating.

The coating compositions of the present invention may be applied to the substrate by any suitable method. Methods of applying the coating compositions of the present invention will be well known to a person skilled in the art. Suitable application methods for the coating compositions of the present invention include, but are not limited to the following: electrocoating such as electrodeposition; spraying; electrostatic spraying; dipping; rolling; brushing; and the like. The coating compositions of the present invention may be applied to the substrate by spraying. Thus, the coating compositions of the present invention may be a spray composition. For the avoidance of doubt, by the term ‘spray composition’ and like terms as used herein is meant, unless specified otherwise, that the coating is suitable to be applied to a substrate by spraying, i.e. is sprayable.

As used herein, unless otherwise expressly specified, all numbers such as those expressing values, ranges, amounts or percentages may be read as if prefaced by the word “about”, even if the term does not expressly appear. Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

Singular encompasses plural and vice versa. For example, although reference is made herein to “a” polyester imide polymer, “a” crosslinker material, “an” imide containing moiety, “an” acid group, “an” alcohol group, and the like, one or more of each of these and any other components can be used. As used herein, the term “polymer” refers to oligomers and both homopolymers and copolymers, and the prefix “poly” refers to two or more.

The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present invention has been described in terms of “comprising”, the coating compositions detailed herein may also be described as “consisting essentially of” or “consisting of”.

As used herein, the term “and/or,” when used in a list of two or more items, means that any one of the listed items can be employed by itself or any combination of two or more of the listed items can be employed. For example, if a list is described as comprising group phenolic resin, amino resin, and/or epoxy resin, the list can comprise phenolic resin alone; amino resin alone; epoxy resin alone; phenolic resin and amino resin in combination; phenolic resin and epoxy resin in combination, amino resin and epoxy resin in combination; or phenolic resin, amino resin, and epoxy resin in combination.

All of the features contained herein may be combined with any of the above in any combination.

For a better understanding of the invention, and to show how embodiments of the same may be carried into effect, reference will now be made, by way of example, to the following examples.

### EXAMPLES

### Polyester Imide (PEI) Example 1

Polyester imide (PEI) example 1 was produced according to the following method.

### Step 1—Preparation of Intermediate OH-Functional PEI

An intermediate polyester imide with predominantly hydroxyl functionality was synthesised. The polymerisation was carried out in a reaction vessel equipped with heating, cooling, stirring and a reflux condenser. A sparge of nitrogen was applied to the reactor to provide an inter atmosphere. 127.7 kg ethylene glycol, 136.3 kilograms (kg) trimellitic anhydride (TMA) and 88.7 kg 4,4′-methylene diphenyl isocyanate (MDI) were charged to the reaction vessel. The mixture was heated to 150° C. and held at 150° C. to 155° C. for 4 hours (during which time, 10 kg of distillate was removed). After this time, 163 kg tris(2-hydroxyethyl) isocyanurate (THEIC), 155.2 kg terephthalic acid and 66.2 kg isophthalic anhydride were added and the reaction vessel was heated to 235° C. under continuous distillation of water. The contents of the reaction vessel were held then at 232° C. to 238° C., again removing water as distillate, until an acid value of <7.0 mg KOH/g and a melt viscosity of 67 poise at 180° C. were achieved. The reaction vessel was then cooled to 200° C. The resin was discharged from the reaction vessel at 200° C.

The resultant resin had an acid value of 6.3 mg KOH/g, a melt viscosity of 71 Poise at 180° C. and a weight average molecular weight (Mw) of 4,847 Da.

### Step 2—Preparation of Acid-Functional PEI

500 kg of the intermediate polyester imide with predominantly hydroxyl functionality produced in step 1 was charged to a reaction vessel equipped with heating, cooling, stirring and a reflux condenser and then heated at 100° C. Then, 60 kg para-tert-butyl benzoic acid was charged to the reaction vessel and the mixture was heated to 220° C. over 2 hours under continuous distillation of water. After this time, the reaction mixture was cooled to 150° C. over 30 min and 150 kg adipic acid was added. Next, the reaction vessel was heated to 210° C. over 1.5 hours, again under continuous distillation of water. After this time, the reaction was quenched by cooling the mixture to 200° C. The resin was discharged from the reaction vessel at 200° C.

The resultant PEI resin had an acid value of 52.5 mg KOH/g, a hydroxyl value of 0 mg KOH/g, a viscosity of 97 poise at 180° C., a glass transition temperature (Tg) of 28° C. and a weight average molecular weight (Mw) of 29,118.

### Polyester Imide (PEI) Comparative Example 1

42.19 grams (g) DESMODUR W (bis(4-isocyanatocyclohexyl)methane available from Bayer Material Science AG), 64.8 g trimellitic anhydride and 71.25 g 1,2-propanediol were charged to a reaction vessel equipped with heating, cooling, stirring and a reflux condenser and heated to 80° C. A sparge of nitrogen was applied to the reactor to provide an inter atmosphere. The reaction vessel was held at 80° C. for 30 minutes to allow foam to subside. The mixture was then heated to 150° C. over a period of 1 hour and then held at this temperature (150° C.) for a further 2.5 hours. After this time, 77.49 g tris hydroxyethylisocyanurate (THEIC), 24.12 g isophthalic acid and 72.37 g terephthalic acid were added to the reaction vessel. The mixture was then heated to distillation with a maximum head temperature of 100° C. The reaction temperature reached 200° C. after 30 minutes and 220° C. after 150 minutes. Once the reaction temperature had reached 220° C., the reaction vessel was maintained at this temperature until an acid value of <7.0 mg KOH/g was achieved. Then, the reaction vessel was cooled to 200° C. before TYZOR TnBT (tetra n-butyl titanate available from Dorf Ketal) was added. The mixture was then stirred for 20 minutes at 200° C. After this time, the contents of the reactor were discharged onto a cooling sheet and allowed to solidify. The solid material was crushed to a powder.

The resultant PEI resin had an acid value of 6.2 mg KOH/g, a hydroxyl value above 10 mg KOH/g, a number average molecular weight (Mn) of 1,850 Da and a weight average molecular weight (Mw) of 29,100 Da.

### Coating Examples 1 to 9

A PEI stock solution (‘PEI stock solution 1’) was prepared according to the formulation in Table 1 and by the following method. All amounts are provided in grams unless specified otherwise.

Components 1 to 5 were mixed for 30 minutes. The resultant mixture was filtered using a 190 micron filter and a stock solution having a solids content of 32 wt % was obtained.

TABLE 1
Formulation of PEI stock solution 1

| | Component | Amount/g |
|---|---|---|
| 1 | PEI example 1 | 75.0 |
| 2 | Benzyl alcohol | 45.9 |
| 3 | Ethyl acetate | 43.8 |
| 4 | Propylene carbonate | 7.6 |
| 5 | Solvesso 100 ¹ | 37.8 |
| | Total | 210.1 |

¹ available from Exxon-Mobil Chemical Company

Coating examples 1 to 9 were prepared according to the formulations in Table 2. All amounts are given in grams unless specified otherwise.

TABLE 2
Formulation of Coating examples 1 to 9

| | Example 1 | Example 2 | Example 3 | Example 4 | Example 5 | Example 6 | Example 7 | Example 8 |
|---|---|---|---|---|---|---|---|---|
| Component | Amount/g | | | | | | | |
| PEI stock solution 1 | 60.00 | 20.00 | 20.00 | 5.00 | 5.00 | 5.00 | 20.00 | 20.00 |
| PRIMID QM-1260 ¹ | 4.00 | — | — | — | — | — | — | — |
| Dowsil RSN-0255 ² | — | 0.99 | — | — | — | — | 0.99 | — |
| Crosslinker stock | — | 2.04 | 2.04 | — | — | — | 2.04 | 2.04 |
| solution 1 ³ | | | | | | | | |
| PBD HTLO R45 ⁴ | — | — | 1.00 | — | — | — | — | 1.00 |
| Xiameter RSN 0255 ⁵ | — | — | 1.99 | — | — | — | — | 0.99 |
| Geniosil GF 93 ⁶ | — | — | — | 0.50 | — | — | — | — |
| Vestanat EP-M 60 ⁷ | — | — | — | — | 0.50 | — | — | — |
| Vestanat EP-M 222 ⁸ | — | — | — | — | — | 0.50 | — | — |
| Dimethylethanolamine | 0.02 | — | — | — | — | — | — | — |
| K-Kat XK 672 ⁹ | — | 0.10 | 0.10 | — | — | — | 0.10 | 0.10 |
| BYK LP g 23116 ¹⁰ | 0.35 | 0.10 | 0.10 | 0.04 | 0.04 | 0.04 | 0.10 | 0.10 |
| Cyclopentanone | — | 0.99 | 0.99 | — | — | — | 0.99 | 0.99 |
| Deionised water | 0.03 | — | — | — | — | — | — | — |
| Total | 64.40 | 24.22 | 26.22 | 5.54 | 5.54 | 5.54 | 24.22 | 25.22 |

¹ β-hydroxyalkylamide crosslinker material available from Chemie AG
² silanol-functional crosslinker material available from Dow
³ a solution having 50 wt % solids formed from 600.0 g Vestagon EP-B 1190 (available from Evonik), 234.2 g ethyl acetate, 40.5 g propylene carbonate, 202.4 g xylene and 122.9 g benzyl alcohol
⁴ polybutadiene crosslinker available from Cray Valley
⁵ polysiloxane crosslinker available from Dow
⁶ silane crosslinkers available from Wacker AG
⁷⁻⁸ silane crosslinkers available from Evonik
⁹ catalyst available from King Industries
¹⁰ additive available from BYK Chemie

### Comparative Example 1

Comparative example 1 is a commercial polyimide amide (PAM) coating available as PPG 8460 from PPG.

### Comparative Example 2

A comparative PEI stock solution (‘comparative PEI stock solution 1’) was prepared by mixing 75 g of comparative PEI example 1 with 75 g of a solvent mixture, the solvent mixture itself formed from 680 g benzyl alcohol, 648 g ethyl lactate, 112 g propylene and 560 g xylene. The resultant solution had a solids content of 50 wt %.

Comparative example 2 was then prepared according to the formulation in Table 3. All amounts are given in grams unless specified otherwise.

TABLE 3
Formulation of comparative example 2

| | Comparative example 2 |
|---|---|
| Component | Amount/g |
| Comparative PEI stock | 100.00 |
| solution 1 | |
| BYK-313 ¹ | 0.90 |
| TEGO WET KL-245 ² | 0.16 |
| KOMELOL 90 GE ³ | 0.73 |
| PHENODUR VPR 1785 ⁴ | 3.80 |
| CYMEL 1123 ⁵ | 1.61 |
| BYK-4510 ac PE ⁶ | 4.38 |
| Tyzor TnBT ⁷ | 4.38 |
| Xylene | 12.43 |
| Benzyl alcohol | 7.83 |
| Ethyl lactate | 10.72 |
| Propylene Carbonate | 15.17 |
| Total | 162.11 |

¹ additive available from BYK Chemie
² additive available from Evonik
³ melamine crosslinker available from Melamin
⁴ phenol crosslinker available from Allnex
⁵ benzoguanamine crosslinker available from Allnex
⁶ additive available from BYK-Altana
⁷ catalyst available from Dorf Ketal

The properties of the coatings were tested via the following methods. Results are shown in Tables 4 and 5.

### Test Methods

Test panel preparation: 1-2 grams of coating examples 1 to 7 and comparative example 1 were each applied onto individual aluminum panels using a doctor knife to give a film thickness of from 9 and 13 μm. The coated panels were placed in a drying cabinet and cured for the time period and temperature provided in Table 4.

Test can preparation: 1-2 grams of coating examples 8 and 9 and comparative coating 2 were each applied onto the interior surface of individual aluminium cans by allowing the coating to run down the sides of said can in a controlled manner and for a defined time to obtain a film thickness of from 9 to 13 μm. The coated cans were placed in a convection oven for the time period and temperature provided in Table 5.

MEK rub test: the number of reciprocating rubs required to remove the coating was measured using a 1 kg hammer covered with a double cotton cloth layer soaked in methyl ethyl ketone. If the coating was not removed after 100 reciprocating rubs were carried out, a score of 100 was recorded. After 100 reciprocating rubs were carried out, the coating panels were then tested for scratch resistance in accordance with the following method.

Scratch resistance: a sharp-edged plastic device was moved along the surface of the panel or can at an angle of 45° (degrees). The level of peeling of the coating from the panel or can was assessed visually. The results were recorded using a rating of 1-5, with 5 being the best (i.e. the coating showing substantially no peeling) and 1 being the worst (i.e. the coating showing significant amounts of peeling).

Impact test: the impact test was carried out according to ASTM 02794. For the cans, the bottom part of the can was cut at a height of 20 mm. The panel or can was then placed on a metal fixture with the coated surface facing down and a 1 kg weight was dropped from a height of 60 cm to strike an indentation. The integrity of the coating was measured using a WACO Enamel Rater Instrument and a 1% salt solution containing 0.1% dioctyl sodium sulfosuccinate. The results were reported in milliamperes (mA).

Coating thickness: coating thickness was measured according to a non-destructive measurement of thermoset coatings applied onto an aluminium base, using the ETAOPTIK (Fluke) coating thickness measuring instrument. The uncoated panel or can was used for calibration. For the measurement of the coating thickness on cans, the measurement was taken after the can had been flatted and the thickness of the coating was measured on the side wall of the can and on the bottom part. The measurement (in microns) was taken 10 times and the thickness was reported as the average of the 10 measurements.

Boiling water tests: the coated part of the panel or can was immersed in boiling demineralised water at 100° C. for 15 minutes. After this time, the panel or can was removed and dried. The panel or can was then tested for cross hatch adhesion, cutting edge adhesion, blush, scratch resistance, crazing after folding and adhesion after folding in accordance with the following test methods.

Cross-cut adhesion: cross-cut adhesion was measured according to DIN ISO 2409. A crosshatch grid was made in the coating film using a grid comb and was then covered by tape (grade TESA 4104 clear). Within 60 seconds of application, the tape was removed rapidly. The grid area was assessed visually for removal of coating from the substrate. The adhesion was scored in accordance with the following scale:

| | |
|---|---|
| GT0 | the edges of the cuts are completely smooth; |
| | none of the squares of the grid is detached. |
| GT1 | small flakes of the coating are detached at |
| | intersections; less than 5% of the area |
| | is affected. |
| GT2 | some flakes of the coating are detached along |
| | the edges and/or at intersections of the incisions. |
| | The area affected is 5-15% of the grid |
| GT3 | The coating has peeled along the edges and on |
| | parts of the squares of the grid. The area |
| | affected is 15-35% of the grid. |
| GT4 | The coating has peeled along the edges of the |
| | incisions in large strips and some squares |
| | are totally detached. The area |
| | affected is 35-65% of the grid. |
| GT5 | All degrees of peeling and flecking that |
| | can be not classified under GT4. |

Cutting edge adhesion: the coated part of the panel or can was cut along the length thereof using scissors. Cutting edge adhesion was assessed visually for the level of peeling from the substrate and recorded using a rating from 1-5, with 5 being the best (i.e. substantially no peeling from the substrate) and 1 being the worst (i.e. significant peeling from the substrate).

Blush: the coated part of the panel or can was compared with an untested control sample (i.e. one that had not undergone boiling water testing). The blush was assessed visually and recorded using a rating from 1-5, with 5 being the best and 1 being the worst.

Bubbles: the coated part of the panel or can was inspected visually. If a bubble formation had been formed within the coating film during the boiling water test, a rating of “yes” was given. If no bubble formation had been formed within the coating film during the boiling water test, a rating of “no” was given.

Frosting after folding: the coated part of the panel or can was folded in half (i.e. at an angle of 180°). The folded area was inspected visually. Frosting (or crazing) was assessed visually and was recorded using a rating from 1-5, with 5 being the best and 1 being the worst.

Adhesion after folding: the coated part of the panel or can was folded in half (i.e. at an angle of 180°). The folded area was then scratched by hand. The adhesion was assessed visually and recorded using a rating from 1-5, with 5 being the best and 1 being the worst.

Solid content: the solid content of the coatings was determined by measuring the weight of the coating composition before and after drying at 120° C. for 60 min.

Gel time measurement: the gel time of coating compositions 1 to 9 and the PEI stock solution 1 was tested using a Geltest GT 16/15 (Coesfield Materialtest). Five drops of coating compositions 1 to 9 or PEI stock solution 1 were applied into the isothermal stirring bowl of the device and stirred permanently with a timber slat. The timer was started when the first drop hit the stirring bowl. As soon as the coating or stock solution began to snap back from the timber slat and become jellylike, the timer was stopped. The gel time was measured in triplicate and the average time was recorded.

Film colour rating: the film colour of the coating was assessed visually.

Wedge-Bend test: a 14 cm×3 cm panel was bent on a 6 mm steel rod to form a U-shaped strip. The U-shaped strip was then placed onto a metal block with a built in tapered recess. A 2 kg weight was dropped onto the recessed block containing the U-shaped strip from a height of 60 cm in order to from a wedge. The test piece was then immersed in a copper sulphate (CuSO₄) solution acidified with hydrochloric acid (HCl) formed from 80 vol % H₂O, 10 vol % CuSO₄ and 10 vol % HCl (37%) for 1 minute, followed by rinsing with tap water. The sample was then carefully dried by blotting any residual water with tissue paper. The length of coating without any fracture was measured. The result was quoted in mm passed. The wedge bends were tested in triplicate and the average value was quoted.

Acid value: the acid value was performed according to the method described herein. The titration was performed using a Metrohm Stat Titrino by titrating the sample solution with 0.1 M solution of KOH in EtOH.

Glass transition temperature (Tg): the Tg was measured according to the method described herein using a Mettler Toledo DSC822e differential scanning calorimeter. 3 mg sample material was positioned in a crucible before being sealed.

TABLE 4
Results for examples on panels

| | | | | | | |
|---|---|---|---|---|---|---|
| | | | | | | Comparative |
| Example 1 | Example 2 | Example 3 | Example 4 | Example 5 | Example 6 | Example 1 |

Panels

| Curing temperature | 230° | C. | 230° | C. | 200° | C. | 200° | C. | 200° | C. | 200° | C. | 230° | C. |
|---|---|---|---|---|---|---|---|---|---|---|---|---|---|---|
| Curing time | 4 | mins | 4 | mins | 4 | mins | 4 | mins | 4 | mins | 4 | mins | 4 | mins |
| MEK rubs | 100 | | 100 | | 100 | | 100 | | 100 | | 100 | | 100 | |
| Scratch resistance | 3.5 | | 4 | | 5 | | 4 | | 3 | | — | | 5 | |
| (after MEK rubs) | | | | | | | | | | | | | | |
| Film thickness | 10 | μm | 11 | μm | 10 | μm | 11 | μm | 11 | μm | 11 | μm | 5 | μm |

| | | | | | | | |
|---|---|---|---|---|---|---|---|
| Film colour | slightly golden | golden | golden | slightly golden | colourless | colourless | golden |
| Frosting | No | No | No | No | No | No | No |

Results after boiling water test

| | | | | | | | |
|---|---|---|---|---|---|---|---|
| Blush | Yes | No | No | — | — | — | No |
| Bubbles | No | No | No | — | — | — | No |
| Cutting edge adhesion | 4 | 4 | 5 | — | — | — | 5 |
| Cross hatch adhesion | GT2 | GT0 | GT0 | — | — | — | GT0 |

TABLE 5
Results for examples on cans

| | | | Comparative |
|---|---|---|---|
| Our ref | Example 7 | Example 8 | Example 2 |

Cans

| Curing temperature | 230° | C. | 230° | C. | 240° | C. |
|---|---|---|---|---|---|---|
| Curing time | 4 | mins | 4 | mins | 5 | mins |
| MEK rubs | 100 | | 100 | | 100 | |
| Scratch resistance | 5 | | 4 | | 5 | |
| (after MEK rubs) | | | | | | |
| Wedge bend | 8 | mm | 13 | mm | 10 | mm |
| Film thickness | 11 | μm | 11 | μm | 11 | μm |

| | | | |
|---|---|---|---|
| Film colour | slightly golden | golden | golden |
| Frosting | No | No | No |

Results after boiling water test

| | | | |
|---|---|---|---|
| Blush | Yes | No | No |
| | (very weak) | | |
| Bubbles | No | No | No |
| Cutting edge | 5 | 4 | 3 |
| adhesion | | | |
| Cross hatch | GT0 | GT0 | GT0 |
| adhesion | | | |

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A coating composition comprising:
a) a polyester imide polymer having an acid value of at least 25 mg KOH/g and a hydroxyl value of up to 5 mg KOH/g; and
b) a crosslinker material operable to crosslink the acid functionality of the polyester imide polymer,
wherein the coating composition is substantially free of bisphenol A (BPA), bisphenol F (BPF), bisphenol A diglycidyl ether (BADGE) and bisphenol F diglycidyl ether (BFDGE).

2. The coating composition according to claim 1, wherein the polyester imide polymer has an acid values of at least 50 mg KOH/g.

3. The coating composition according to claim 1, wherein the polyester imide material has a hydroxyl value of 0 (zero) mg KOH/g.

4. The coating composition according to claim 1, wherein the crosslinker material comprises isocyanate resins, hydroxy (alkyl) amide resins, hydroxy(alkyl) urea resins, carbodiimide resins, oxazolines, silanes; silane end-capped polymers; polysiloxanes, polyether polyols or combinations thereof.

5. The coating composition according to claim 1, wherein the coating composition comprises from 60 to 90 wt % of the polyester imide, based on the total solid weight of the coating composition.

6. The coating composition according to claim 1, wherein the coating composition comprises from 10 to 40 wt % of the crosslinker material based on the total solid weight of the coating composition.

7. The coating composition according to claim 1, wherein the coating composition is a liquid composition.

8. A metal substrate coated on at least a portion thereof with a coating, the coating being derived from a coating composition, the coating composition comprising:
a) a polyester imide polymer having an acid value of at least 25 mg KOH/g and a hydroxyl value of up to 5 mg KOH/g; and
b) a crosslinker material operable to crosslink the acid functionality on the polyester imide polymer,
wherein the coating composition is substantially free of bisphenol A (BPA), bisphenol F (BPF), bisphenol A diglycidyl ether (BADGE) and bisphenol F diglycidyl ether (BFDGE).

9. A package coated on at least a portion thereof with a coating, the coating being derived from a coating composition, the coating composition comprising:
a) a polyester imide polymer having an acid value of at least 25 mg KOH/g and a hydroxyl value of up to 5 mg KOH/g; and
b) a crosslinker material operable to crosslink the acid functionality on the polyester imide polymer,
wherein the coating composition is substantially free of bisphenol A (BPA), bisphenol F (BPF), bisphenol A diglycidyl ether (BADGE) and bisphenol F diglycidyl ether (BFDGE).

10. The package according to claim 9, wherein the package is a food and/or beverage packaging.

11. The package according to claim 9, wherein the package is a monobloc aerosol can and/or tube.

12-14. (canceled)
